(19) United States
(12) Patent Application Publication
(10) Pub. No.: US 2026/0063836 A1
(43) Pub. Date: Mar. 5, 2026

(54) MULTIMODE OPTICAL FIBERS

(71) Applicant: CORNING INCORPORATED, CORNING, NY (US)

(72) Inventors: Ashley Anne Holman, Leland, NC (US); Adrian Alejando Juarez Marroquin, Wellsboro, PA (US); Snigdharaj Kumar Mishra, Wilmington, NC (US); Benjamin Pelham Schrock, Wilmington, NC (US)

(21) Appl. No.: 19/285,266

(22) Filed: Jul. 30, 2025

Related U.S. Application Data
(60) Provisional application No. 63/690,455, filed on Sep. 4, 2024.

(51) Int. Cl. G02B 6/028

(52) U.S. Cl. CPC G02B 6/0288

(57) ABSTRACT

A multimode optical fiber includes a core portion comprising an α-profile, a core maximum relative refractive index Δ_{Cmax}, and a core minimum relative refractive index Δ_{Cmin}. Δ_{Cmax} may be ≤0.85 Δ% and ≥−0.1 Δ%, Δ_{Cmax}>Δ_{Cmin}, and Δ_{Cmin} may be <0 Δ%. A depressed index trench portion surrounds the core portion. The depressed index trench portion has a minimum relative refractive index Δ_{Tmin}. A shelf portion surrounds the depressed index trench portion. The shelf portion has a maximum relative refractive index Δ_{Smax}. An outer cladding portion surrounds the shelf portion. The outer cladding portion has a relative refractive index Δ_{OC}. In embodiments, Δ_{Cmin}>Δ_{Tmin}, Δ_{Cmax}>Δ_{Smax}, Δ_{Smax}>Δ_{Tmin}, and Δ_{Smax}>Δ_{OC}. Each of the core portion, the depressed index trench portion, and the outer cladding portion may be formed from silica-based glass down-doped with fluorine.

This application claims the benefit of priority under 35 U.S.C. § 119 of U.S. Provisional Application Ser. No. 63/690,455 filed on Sep. 4, 2024, the content of which is relied upon and incorporated herein by reference in its entirety.

### FIELD

The present specification generally relates to optical fibers and, more specifically, to multimode optical fibers with core portions and cladding portions doped with fluorine.

### TECHNICAL BACKGROUND

Optical fiber has become accepted as a viable alternative to traditional materials used for data signal communication and is now widely utilized in a variety of electronic systems to facilitate high-speed communication of data signals between various components. As the speed and bandwidth of digital electronic components continues to increase, so too does the need for optical fibers capable of communicatively coupling these electronic components while maintaining both the speed and bandwidth of the electronic components.

In addition, bending losses associated with optical fibers may also limit the utility of optical fibers in certain applications, such as fiber to the home applications (i.e., fiber home networks). For example, in certain applications, the ability to form a tight bending diameter of 20 mm or less in an optical fiber with negligible bending losses may be desirable.

Accordingly, a need exists for alternative optical fiber designs which allow for high bandwidths and which may also have low bending losses.

### SUMMARY

According to a first aspect A1, a multimode optical fiber comprises: a core portion comprising an α-profile, a core maximum relative refractive index Δ_{Cmax} at or proximate a centerline of the core portion, and a core minimum relative refractive index Δ_{Cmin} at an outer radius of the core portion, wherein Δ_{Cmax} is less than or equal to 0.85 Δ% and greater than or equal to −0.1 Δ%, Δ_{Cmax}>Δ_{Cmin}, and Δ_{Cmin} is less than 0 Δ%; a depressed index trench portion circumferentially surrounds the core portion, the depressed index trench portion comprising a minimum relative refractive index Δ_{Tmin}; a shelf portion circumferentially surrounding and directly contacting the depressed index trench portion, the shelf portion comprising a maximum relative refractive index Δ_{Smax}; and an outer cladding portion circumferentially surrounding and directly contacting the shelf portion, the outer cladding portion comprising a relative refractive index Δ_{OC}, wherein: Δ_{Cmin}>Δ_{Tmin}, Δ_{Cmax}>Δ_{Smax}, Δ_{Smax}>Δ_{Tmin}; Δ_{Smax}>Δ_{OC}; each of the core portion, the depressed index trench portion, and the outer cladding portion comprise silica-based glass down-doped with fluorine; and the multimode optical fiber is multimoded at wavelengths up to 1600 nm.

A second aspect A2 includes the multimode optical fiber of aspect A1 wherein Δ_{OC}≥Δ_{Tmin}.

A third aspect A3 incudes the multimode optical fiber of aspect A1, wherein Δ_{OC}<Δ_{Tmin}.

A fourth aspect A4 incudes the multimode optical fiber of any of the preceding aspects, wherein Δ_{Smax}≥Δ_{Cmin}.

A fifth aspect A5 incudes the multimode optical fiber of any of the preceding aspects, wherein a core absolute relative refractive index Δ_{Cabs} of the core portion is greater than or equal to 0.85 Δ% and less than or equal to 1.3 Δ%.

A sixth aspect A6 incudes the multimode optical fiber of any of the preceding aspects, wherein an α-value of the α-profile of the core portion is greater than or equal to 1.75 and less than or equal to 2.25 such that the α-profile is parabolic.

A seventh aspect A7 incudes the multimode optical fiber of any of the preceding aspects, wherein Δ_{Cmin} is less than or equal to 0 Δ% and greater than or equal to −1 Δ%.

An eighth aspect A8 incudes the multimode optical fiber of any of the preceding aspects, wherein Δ_{Cmax} is less than or equal to 0.0 Δ% and greater than or equal to −0.1 Δ%.

A ninth aspect A9 incudes the multimode optical fiber of any of the preceding aspects, wherein the core portion further comprises GeO₂.

A tenth aspect A10 includes the multimode optical fiber of aspect A9, wherein: a concentration of GeO₂ in the core portion is a maximum at or proximate the centerline of the core portion and decreases from the maximum in an outward radial direction relative to the centerline; and a concentration of fluorine in the core portion is a minimum at or proximate the centerline of the core portion.

An eleventh aspect A11 includes the multimode optical fiber of aspect A9, wherein the concentration of fluorine is a maximum at the outer radius of the core portion.

A twelfth aspect A12 includes the multimode optical fiber of any of aspects A10-A11, wherein the concentration of fluorine increases from a point between the centerline of the core portion and the outer radius of the core portion.

A thirteenth aspect A13 includes the multimode optical fiber of A9, wherein: a concentration of GeO₂ in the core portion is substantially uniform throughout the core portion; and a concentration of fluorine in the core portion is a minimum at or proximate the centerline of the core portion and increases from the minimum in an outward radial direction relative to the centerline.

A fourteenth aspect A14 includes the multimode optical fiber of aspect A9, wherein: a concentration of fluorine in the core portion is substantially uniform throughout the core portion; and a concentration of GeO₂ in the core portion is a maximum at or proximate the centerline of the core portion and decreases from the maximum in an outward radial direction relative to the centerline.

A fifteenth aspect A15 includes the multimode optical fiber of any of aspects A9-A14, wherein a maximum concentration of GeO₂ in the core portion is greater than 0 wt % and less than or equal to 20.5 wt %.

A sixteenth aspect A16 includes the multimode optical fiber of any of aspects A9-A15, wherein a maximum concentration of fluorine in the core portion is greater than 0 wt % and less than or equal to 7.5 wt %.

A seventeenth aspect A17 includes the multimode optical fiber of Aspect A9, wherein a concentration of fluorine in the core portion is a minimum at or proximate the centerline of the core portion and increases from the minimum in an outward radial direction relative to the centerline.

An eighteenth aspect A18 includes the multimode optical fiber of any of aspects A1-A8, wherein: a maximum concentration of fluorine in the core portion is greater than 0 wt % and less than or equal to 7.5 wt %.

A nineteenth aspect A19 includes the multimode optical fiber of any preceding aspect, wherein the core portion comprises a radial width greater than or equal to 15 μm and less than or equal to 35 μm.

A twentieth aspect A20 includes the multimode optical fiber of any preceding aspect, wherein Δ_{Tmin} is greater than or equal to −1.5 Δ% and less than or equal to −0.2 Δ%.

A twenty-first aspect A21 includes the multimode optical fiber of any preceding aspect, wherein a maximum concentration of fluorine in the depressed index trench portion is greater than 0 wt % and less than or equal to 7.5 wt %.

A twenty-second aspect A22 includes the multimode optical fiber of any preceding aspect, wherein the depressed index trench portion comprises a trench volume of greater than or equal to 40 Δ%-μm² and less than or equal to 300 Δ%-μm².

A twenty-third aspect A23 includes the multimode optical fiber of any preceding aspect, wherein the depressed index trench portion comprises a radial width of greater than or equal to 2 μm and less than or equal to 15 μm.

A twenty-fourth aspect A24 includes the multimode optical fiber of any preceding aspect, wherein the shelf portion is pure silica glass.

A twenty-fifth aspect A25 includes the multimode optical fiber of any of aspects A1-A23, wherein the shelf portion comprises fluorine.

A twenty-sixth aspect A26 includes the multimode optical fiber of aspect A25, wherein a maximum concentration of fluorine in the shelf portion is greater than or equal to 0 wt % and less than or equal to 1.4 wt %.

A twenty-seventh aspect A27 includes the multimode optical fiber of any preceding aspect, wherein Δ_{Smax} is greater than or equal to −0.4 Δ% and less than or equal to 0 Δ%.

A twenty-eighth aspect A28 includes the multimode optical fiber of any preceding aspect, wherein the shelf portion comprises a radial width greater than 0 μm and less than or equal to 10 μm.

A twenty-ninth aspect A29 includes the multimode optical fiber of any preceding aspect, wherein Δ_{OC} is greater than or equal-1.5 Δ% and less than or equal to −0.2 Δ%.

A thirtieth aspect A30 includes the multimode optical fiber of any preceding aspect, wherein a concentration of fluorine in the outer cladding portion is greater 0 wt % to less than or equal to 7.5 wt %.

A thirty-first aspect A31 includes the multimode optical fiber of any preceding aspect, wherein an outer radius of the outer cladding portion is 62.5 μm.

A thirty-second aspect A32 includes the multimode optical fiber of any preceding aspect, wherein the multimode optical fiber comprises a bandwidth of greater than or equal to 0.05 GHz-km and less than or equal to 10 for each wavelength within a wavelength operating window centered on at least one wavelength within an operating wavelength range from about 820 nm to about 1310 nm, the wavelength operating window having a width greater than 100 nm.

A thirty-third aspect A33 includes the multimode optical fiber of any preceding aspect, wherein the multimode optical fiber comprises an effective modal bandwidth according to IEC 60793-1-49 of greater than or equal to 0.020 GHz-km and less than or equal to 10.000 GHz-km.

A thirty-fourth aspect A34 includes the multimode optical fiber of any preceding aspect, wherein the multimode optical fiber comprises an OFL bandwidth of greater than or equal to 0.050 GHz-km and less than or equal to 10.000 GHz-km.

A thirty-fifth aspect A35 includes the multimode optical fiber of any preceding aspect, wherein the multimode optical fiber has a macrobend loss of less than or equal to 0.50 db/(2 turns around a 15 mm diameter mandrel) at 850 nm.

A thirty-sixth aspect A36 includes the multimode optical fiber of any preceding aspect, wherein the multimode optical fiber has a macrobend loss of less than or equal to 0.50 db/(2 turns around a 15 mm diameter mandrel) at 1300 nm.

A thirty-seventh aspect A37 includes the multimode optical fiber of any preceding aspect, wherein the multimode optical fiber comprises a numerical aperture of greater than or equal to 0.150 and less than or equal to 0.250.

A thirty-eighth aspect A38 includes the multimode optical fiber of any preceding aspect, wherein the multimode optical fiber comprises an attenuation of less than 0.25 db/km at a wavelength of 1310 nm.

Additional features and advantages of the multimode optical fibers described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a radial cross section of a multimode optical fiber according to one or more embodiments shown and described herein;

FIG. 2 graphically depicts the relative refractive index profile of the multimode optical fiber of FIG. 1 as a function of the radius R of the glass portion of the multimode optical fiber;

FIG. 3 graphically depicts the relative refractive index (Y-axis) as a function of fiber radius (X-axis) for example multimode optical fibers according to embodiments described herein and for a comparative multimode optical fiber;

FIG. 4 graphically depicts the relative refractive index (Y-axis) as a function of fiber radius (X-axis) for example multimode optical fibers according to embodiments described herein and for a comparative multimode optical fiber;

FIG. 5 graphically depicts the relative refractive index (Y-axis) as a function of fiber radius (X-axis) for example multimode optical fibers according to embodiments described herein and for a comparative multimode optical fiber;

FIG. 6 graphically depicts the relative refractive index (Y-axis) as a function of fiber radius (X-axis) for example multimode optical fibers according to embodiments described herein and for a comparative multimode optical fiber;

FIG. 7 graphically depicts the effective modal bandwidth (Y-axis) as a function of wavelength (X-axis) for example multimode optical fibers according to embodiments described herein and for a comparative multimode optical fiber;

FIG. 8 graphically depicts the doping concentration of GeO₂ and fluorine (Y-axis) as a function of fiber radius (X-axis) for a comparative multimode optical fiber;

FIG. 9A graphically depicts an example of a doping concentration of GeO₂ and fluorine (Y-axis) as a function of fiber radius (X-axis) for one or more multimode optical fibers described herein;

FIG. 9B graphically depicts an example of a doping concentration of GeO₂ and fluorine (Y-axis) as a function of fiber radius (X-axis) for one or more multimode optical fibers described herein;

FIG. 9C graphically depicts an example of a doping concentration of GeO₂ and fluorine (Y-axis) as a function of fiber radius (X-axis) for one or more multimode optical fibers described herein;

FIG. 10A graphically depicts an example of a doping concentration of GeO₂ and fluorine (Y-axis) as a function of fiber radius (X-axis) for one or more multimode optical fibers described herein;

FIG. 10B graphically depicts an example of a doping concentration of GeO₂ and fluorine (Y-axis) as a function of fiber radius (X-axis) for one or more multimode optical fibers described herein;

FIG. 10C graphically depicts an example of a doping concentration of GeO₂ and fluorine (Y-axis) as a function of fiber radius (X-axis) for one or more multimode optical fibers described herein;

FIG. 11A graphically depicts an example of a doping concentration of GeO₂ and fluorine (Y-axis) as a function of fiber radius (X-axis) for one or more multimode optical fibers described herein;

FIG. 11B graphically depicts an example of a doping concentration of GeO₂ and fluorine (Y-axis) as a function of fiber radius (X-axis) for one or more multimode optical fibers described herein;

FIG. 11C graphically depicts an example of a doping concentration of GeO₂ and fluorine (Y-axis) as a function of fiber radius (X-axis) for one or more multimode optical fibers described herein; and

FIG. 12 graphically depicts an example of a doping concentration of GeO₂ and fluorine (Y-axis) as a function of fiber radius (X-axis) for one or more multimode optical fibers described herein.

### DETAILED DESCRIPTION

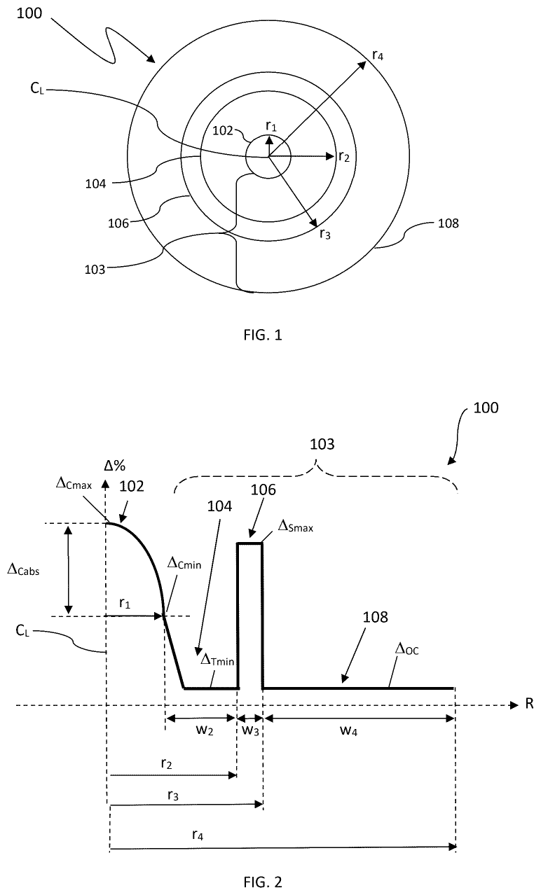

Reference will now be made in detail to embodiments of the multimode optical fibers described herein, examples of which are illustrated in the accompanying drawings. Whenever possible, the same reference numerals will be used throughout the drawings and description to refer to the same or like parts. A cross section of an embodiment of a multimode optical fiber 100 is schematically depicted in FIG. 1 and the relative refractive index profile of the multimode optical fiber is graphically depicted in FIG. 2. In embodiments, the multimode optical fiber generally comprises a core portion comprising an α-profile, a core maximum relative refractive index Δ_{Cmax} at or proximate a centerline of the core portion, and a core minimum relative refractive index Δ_{Cmin} at an outer radius of the core portion. Δ_{Cmax} may be less than or equal to 0.85 Δ% and greater than or equal to −0.1 Δ%, Δ_{Cmax}>Δ_{Cmin}, and Δ_{Cmin} may be less than 0 Δ%. A depressed index trench portion circumferentially surrounds the core portion. The depressed index trench portion has a minimum relative refractive index Δ_{Tmin}. A shelf portion circumferentially surrounds and directly contacts the depressed index trench portion. The shelf portion has a maximum relative refractive index Δ_{Smax}. An outer cladding portion circumferentially surrounds and directly contacts the shelf portion. The outer cladding portion has a relative refractive index Δ_{OC}. In embodiments, Δ_{Cmin}>Δ_{Tmin}, Δ_{Cmax}≥Δ_{Smax}, Δ_{Smax}>Δ_{Tmin}, and Δ_{Smax}>Δ_{OC}. Each of the core portion, the depressed index trench portion, and the outer cladding portion may be formed from silica-based glass down-doped with fluorine. The multimode optical fiber may be multimoded at wavelengths up to 1600 nm. Various embodiments of multimode optical fibers and the properties thereof will be described herein with specific reference to the appended drawings.

The following terminology will be used in conjunction with the optical fibers described herein:

The term “refractive index profile” or “relative refractive index profile,” as used herein, is the relationship between the refractive index or the relative refractive index and the radius R of the fiber.

The term “relative refractive index,” as used herein, is defined as:

$$Δ ( r ) \% = 100 \times ( ( n ( r ) \hat{} 2 - n\_REF \hat{} 2 ) ) / ( 2 n ( r ) \hat{} 2 ) , \qquad ( 1 )$$

where n(r) is the refractive index at radius r of the optical fiber, unless otherwise specified. The relative refractive index is defined at 1550 nm unless otherwise specified. The reference index BREF is pure silica glass (i.e., silica glass with an index of refraction of 1.444 at 1550 nm such that n_{REF}=1.444). As used herein, the relative refractive index is represented by Δ and its values are given in units of “Δ%,” unless otherwise specified. In cases where the refractive index of a region is less than the reference index n_{REF}, the relative index percent is negative and is referred to as having a depressed region or depressed-index, and the minimum relative refractive index is calculated at the point at which the relative index is most negative unless otherwise specified. In cases where the refractive index of a region is greater than the reference index n_{REF}, the relative index percent is positive and the region can be said to be raised or to have a positive index.

The term “up-dopant,” as used herein, refers to a dopant that raises the refractive index of glass relative to pure, undoped SiO₂. Examples of up-dopants may include, for example and without limitation, GeO₂ (also referred to herein as “germania”). The term “down-dopant,” as used herein, is a dopant that has a propensity to lower the refractive index of glass relative to pure, undoped SiO₂. Examples of down-dopants may include, for example and without limitation, F—(also referred to herein as “fluorine”). An up-dopant may be present in a region of an optical fiber having a negative relative refractive index when accompanied by one or more other dopants that are not up-dopants. Likewise, one or more other dopants that are not up-dopants (such as down-dopants) may be present in a region of an optical fiber having a positive relative refractive index. A down-dopant may be present in a region of an optical fiber having a positive relative refractive index when accompanied by one or more other dopants that are not down-dopants (such as up-dopants). Likewise, one or more other dopants that are not down-dopants (such as up-dopants) may be present in a region of an optical fiber having a negative relative refractive index.

The term “α-profile” or “alpha profile,” as used herein, refers to a relative refractive index profile, expressed in terms of Δ which is in units of “Δ%,” which follows the equation,

$$Δ ( r ) = {Δ}_{Cmax} ( 1 - {[ \frac{\vert r \vert}{( {r}_{1} )} ]}^{α} ) , \qquad ( 2 )$$

where Δ_{Cmax} is the maximum relative refractive index of the core portion, r is the radius, r₁ is the largest radius of the core portion (which corresponds to the radius of the core portion at the base of the parabolic shape in the relative refractive index profile), r is in the range rᵢ≤r≤r_{f}, Δ_{Cmax} is as defined above, rᵢ is the initial point of the α-profile, rr is the final point of the α-profile, and a (also referred to as “alpha,” “α-value,” or “alpha value”) is an exponent which is a real number. For a graded index profile, the α-value is less than 10. The term “parabolic,” as used herein, includes substantially parabolically shaped refractive index profiles which may vary from an α-value of 2.0 at one or more points in the core portion, as well as profiles with minor variations and/or a centerline dip. In embodiments described herein, the α-value may be greater than or equal to 1.75 and less than or equal to 2.25.

Macrobend performance is determined according to FOTP-62 (JEC-60793-1-47) by wrapping 2 turns of optical fiber around a 15 mm and/or a 30 mm diameter mandrel and measuring the increase in attenuation due to the bending using an encircled flux (EF) launch condition (also referred to as a “restricted launch condition”).

The overfilled launch (OFL) bandwidth of the multimode optical fiber is measured at 850 nm according to IEC 60793-1-41 (TIA-FOTP-204), Measurement Methods and Test Procedures-Bandwidth, using overfilled launch conditions.

The effective modal bandwidth of the multimode optical fiber is measured according to IEC 60793-1-49 (TIA/EIA-455-220), Measurement Methods and Test Procedures-Differential Mode Delay.

The numerical aperture (NA) of an optical fiber means the numerical aperture as measured using the method set forth in IEC-60793-1-43 (TIA SP3-2839-URV2 FOTP-177) entitled “Measurement Methods and Test Procedures-Numerical Aperture.” The numerical aperture or NA_{C} of the core portion of the multimode optical fiber is directly related to the maximum relative refractive index Δ_{Cmax} of the core portion (referenced to the refractive index n₄ of the outer cladding portion) according to the relationship:

$${NA}_{C} = {n}_{4} \sqrt{\frac{2 Δ {C}_{max}}{1 - 2 Δ {C}_{max}}} . \qquad ( 3 )$$

Attenuation of the multimode optical fibers described herein may be measured using an Optical Time Domain Reflectometer (OTDR).

Unless otherwise specified herein, measurements of the properties of the optical fiber are taken at an operating wavelength of at least one of 850 nm, 980 nm, 1060 nm, or 1310 nm, unless otherwise specified.

The terms “microns” and “μm” are used interchangeably herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The core portions of conventional multimode optical fibers comprise silica-based glass up-doped with germania (GeO₂) to increase the refractive index of the glass and create a graded index profile to enhance light and mode propagation. In these multimode optical fibers, the peak (i.e., the maximum) relative refractive index of the core portion is approximately 1 Δ% relative to pure (undoped) silica.

However, the use of GeO₂ in the glass has several drawbacks. For example, GeO₂ is relatively expensive and therefore the use of GeO₂ in the core portion of multimode optical fibers increases the overall cost of the fibers. Further, incorporating GeO₂ in the glass introduces stress in the glass during the manufacture of the preforms from which the multimode optical fibers are drawn. This stress can lead to cracking or shattering (also referred to as “crizzle”) of the preform during manufacture, necessitating that the preform be discarded as waste glass. Production losses from crizzle due to the incorporation of GeO₂ in the glass decrease fiber yields and increase manufacturing costs.

The embodiments described herein mitigate these issues by reducing (or even eliminating) GeO₂ in the core portion of the multimode optical fibers. In particular, the multimode optical fibers described herein utilize the down-dopant fluorine in the core portion (in addition to fluorine in the depressed index trench portion and the outer cladding portion) to replace at least a portion of the GeO₂ in the core portion of the multimode optical fiber. The addition of fluorine in the core portion of the multimode optical fiber lowers the overall refractive index of the multimode optical fiber while still maintaining the desired α-profile in the core portion and a desired absolute relative refractive index in the core portion. The reduction in refractive index in the core portion equates to lower attenuation of optical signals propagating in the multimode optical fiber. Further, the reduction of GeO₂ reduces production costs and improves manufacturing yields by reducing or mitigating stresses due to GeO₂ in the preforms from which the multimode optical fibers are drawn.

Referring now to the figures, FIG. 1 schematically depicts a cross section of one embodiment of a multimode optical fiber. The optical fibers described herein are multimode optical fibers meaning that the fibers support the propagation of multiple modes of electromagnetic radiation at wavelengths up to and including 1600 nm or even greater. The multimode optical fibers generally comprise a core portion and a cladding portion. The cladding portion comprises a depressed index trench portion, a shelf portion, and an outer cladding portion. The structure and composition of the multimode optical fibers as well as the properties of the multimode optical fibers will be described in further detail herein.

Referring to FIGS. 1 and 2, a cross section of one embodiment of a multimode optical fiber 100 (FIG. 1) and the corresponding relative refractive index profile (FIG. 2) of the multimode optical fiber 100 are depicted. The multimode optical fiber 100 generally comprises a core portion 102 and a cladding portion 103. In the embodiments described herein, the core portion 102 is positioned within the cladding portion 103. The core portion 102 and the cladding portion 103 are concentric such that the cross section of the multimode optical fiber 100 is generally circular symmetric with respect to the centerline C_{L} of the core portion 102. In the embodiments described herein, the centerline C_{L} of the core portion 102 also corresponds to the centerline of the multimode optical fiber 100. The cladding portion 103 comprises a depressed index trench portion 104, a shelf portion 106, and an outer cladding portion 108. The depressed index trench portion 104, the shelf portion 106, and the outer cladding portion 108 are arranged such that the depressed index trench portion 104 is disposed between the core portion 102 and the shelf portion 106 and the shelf portion 106 is positioned between the depressed index trench portion 104 and the outer cladding portion 108. In embodiments described herein, the depressed index trench portion 104 circumferentially surrounds the core portion 102, the shelf portion 106 circumferentially surrounds the depressed index trench portion 104, and the outer cladding portion 108 circumferentially surrounds the shelf portion 106. In embodiments described herein, the depressed index trench portion 104 may circumferentially surround and directly contact the core portion 102. In embodiments described herein, the shelf portion 106 may circumferentially surround and directly contact the depressed index trench portion 104. In embodiments described herein, the outer cladding portion 108 may circumferentially surround and directly contacts the shelf portion 106.

In the embodiments described herein, the core portion 102, the depressed index trench portion 104, and the outer cladding portion 108 each comprise silica, specifically silica-based glass, down-doped with fluorine. In embodiments, the shelf portion 106 may comprise pure silica glass or silica-based glass down-doped with fluorine.

Still referring to FIGS. 1 and 2, the core portion 102 has a radius r₁ (also referred to as the outer radius of the core portion 102). The radius r₁ corresponds to the radial width of the core portion 102. The depressed index trench portion 104 extends from the radius r₁ to the radius r₂ such that the depressed index trench portion 104 has a radial width w₂=r₂−r₁. The shelf portion 106 extends from the radius r₂ to the radius r₃ such that the shelf portion has a radial width w₃=r₃-r₂. The outer cladding portion 108 extends from the radius r₃ to the radius r₄ (also referred to as the outer radius of the outer cladding portion 108 and/or the outer radius of the glass portion of the multimode optical fiber 100) such that the outer cladding portion has a radial width of w₄=r₄−r₃. Accordingly, the glass portion of the multimode optical fiber 100 (e.g., the core portion 102, the depressed index trench portion 104, the shelf portion 106, and the outer cladding portion 108) may have a diameter of 2r₄. In embodiments, the diameter of the glass portion of the optical fiber may be greater than 100 μm and less than 130 μm. In particular embodiments, the diameter of the glass portion of the optical fiber is 125 μm (i.e., r₄=62.5 μm).

The core portion 102 has an index of refraction n₁ and is formed with a graded index profile (i.e., an α-profile). For example, in the embodiments of the multimode optical fiber 100 described herein, the core portion 102 has an α-profile, as is graphically depicted in FIG. 2. As such, the core portion 102 has a maximum relative refractive index Δ_{Cmax} relative to pure silica glass at or proximate to the centerline C_{L} of the core portion 102. Although not depicted in FIG. 2, in embodiments, the refractive index of the core portion 102 may have a centerline dip such that the maximum refractive index of the core portion 102 and the maximum refractive index of the entire multimode optical fiber 100 is located a small distance away from the centerline C_{L} of the core portion 102 rather than at the centerline C_{L} of the core portion 102, as depicted in FIG. 2. In the embodiment of the multimode optical fiber 100 depicted in FIG. 2, the relative refractive index of the core portion 102 decreases with increasing radius from the centerline C_{L} of the core portion 102 such that the core portion has a minimum relative refractive index Δ_{Cmin} at the outer radius of the core portion (i.e., at r₁). In the embodiments described herein, the core portion 102 has an α-value (i.e., a) which is greater than or equal to 1.75 and less than or equal to 2.25. In embodiments, the α-value may be greater than or equal to 1.95 and less than or equal to 2.25, greater than or equal to 1.95 and less than or equal to 2.15, greater than or equal to 2.0 and less than or equal to 2.2, or even greater than or equal to 2.02 and less than or equal to 2.05. The above ranges include all subranges within the explicitly disclosed ranges as well as ranges formed from any combination of the endpoints thereof.

The depressed index trench portion 104 has an index of refraction n₂ and a corresponding minimum relative refractive index Δ_{Tmin} relative to pure silica glass. The shelf portion 106 may have an index of refraction n₃ and a corresponding maximum relative refractive index Δ_{Smax} relative to pure silica glass. In the embodiments described herein, Δ_{Cmax}>Δ_{Cmin}, Δ_{Cmin}>Δ_{Tmin}, Δ_{Cmax}≥Δ_{Smax}, and Δ_{Smax}>Δ_{Tmin}, as graphically depicted in FIG. 2. In embodiments, Δ_{Smax}≥Δ_{Cmin}. In embodiments, Δ_{Smax}<Δ_{Cmin}. In the embodiments described herein, the depressed relative refractive index of the depressed index trench portion 104 relative to the core portion 102 improves the bend resistance of the multimode optical fiber 100.

The outer cladding portion 108 of the multimode optical fiber 100 may comprise an index of refraction n₄ and a relative refractive index Δ_{OC} relative to pure silica glass. In the embodiments described herein, the relative refractive index Δ_{OC} of the outer cladding portion 108 is less than Δ_{Cmax} and less than Δ_{Smax}. In embodiments, the relative refractive index Δ_{OC} of the outer cladding portion 108 may be less than the minimum relative refractive index Δ_{Cmin} of the core portion 102. In embodiments, the relative refractive index Δ_{OC} of the outer cladding portion 108 may be greater than or equal to the minimum relative refractive index Δ_{Tmin} of the depressed index trench portion 104. In embodiments, the relative refractive index Δ_{OC} of the outer cladding portion 108 may be less than the minimum relative refractive index Δ_{Tmin} of the depressed index trench portion 104.

The radius r₁ of the core portion 102 (i.e., the radial width of the core portion 102) is greater than or equal to 15 μm and less than or equal to 35 μm, greater than or equal to 20 μm and less than or equal to 30 μm, or even greater than or equal to 22.5 μm and less than or equal to 27.5 μm. The above ranges include all subranges within the explicitly disclosed ranges as well as ranges formed from any combination of the endpoints thereof.

As noted herein, the core portion 102 of the multimode optical fiber 100 comprises a core maximum relative refractive index Δ_{Cmax} at or proximate a centerline C_{L} of the core portion 102 and a core minimum relative refractive index Δ_{Cmin} at an outer radius of the core portion 102 (i.e., at the radius r₁). In the embodiments described herein, Δ_{Cmax}>Δ_{Cmin}. In the embodiments described herein, the core maximum relative refractive index Δ_{Cmax} of the core portion 102 is greater than or equal to −0.1 Δ% and less than or equal to 0.85 Δ%. In embodiments, the core maximum relative refractive index Δ_{Cmax} of the core portion 102 may be greater than or equal to −0.1 Δ% and less than or equal to 0.80 Δ%, greater than or equal to −0.1 Δ% and less than or equal to 0.75 Δ%, greater than or equal to −0.1 Δ% and less than or equal to 0.70 Δ%, greater than or equal to −0.1 Δ% and less than or equal to 0.65 Δ%, greater than or equal to −0.1 Δ% and less than or equal to 0.60 Δ%, greater than or equal to −0.1 Δ% and less than or equal to 0.55 Δ%, greater than or equal to −0.1 Δ% and less than or equal to 0.50 Δ%, greater than or equal to −0.1 Δ% and less than or equal to 0.45 Δ%, greater than or equal to −0.1 Δ% and less than or equal to 0.40 Δ%, greater than or equal to −0.1 Δ% and less than or equal to 0.35 Δ%, greater than or equal to −0.1 Δ% and less than or equal to 0.30 Δ%, greater than or equal to −0.1 Δ% and less than or equal to 0.25 Δ%, greater than or equal to −0.1 Δ% and less than or equal to 0.20 Δ%, greater than or equal to −0.1 Δ% and less than or equal to 0.15 Δ%, greater than or equal to −0.1 Δ% and less than or equal to 0.10 Δ%, greater than or equal to −0.1 Δ% and less than or equal to 0.05 Δ%, or even greater than or equal to −0.1 Δ% and less than or equal to 0.00 Δ%. The above ranges include all subranges within the explicitly disclosed ranges as well as ranges formed from any combination of the endpoints thereof.

In the embodiments described herein, the core minimum relative refractive index Δ_{Cmin} of the core portion 102 of the multimode optical fiber 100 is less than 0 Δ% and greater than or equal to −1.0 Δ%. In embodiments, the core minimum relative refractive index Δ_{Cmin} of the core portion 102 may be less than 0 Δ% and greater than or equal to −0.9 Δ%, less than 0 Δ% and greater than or equal to −0.8 Δ%, less than 0 Δ% and greater than or equal to −0.7 Δ%, less than 0 Δ% and greater than or equal to −0.6 Δ%, less than 0 Δ% and greater than or equal to −0.5 Δ%, less than 0 Δ% and greater than or equal to −0.4 Δ%, less than 0 Δ% and greater than or equal to −0.3 Δ%, less than 0 Δ% and greater than or equal to −0.2 Δ%, or even less than 0 Δ% and greater than or equal to −0.1 Δ%. In embodiments, the core minimum relative refractive index Δ_{Cmin} of the core portion 102 may be less than or equal to −0.1 Δ% and greater than or equal to −0.9 Δ%, less than or equal to −0.1 Δ% and greater than or equal to −0.8 Δ%, less than or equal to −0.1 Δ% and greater than or equal to −0.7 Δ%, less than or equal to −0.1 Δ% and greater than or equal to −0.6 Δ%, less than or equal to −0.1 Δ% and greater than or equal to −0.5 Δ%, less than or equal to −0.1 Δ% and greater than or equal to −0.4 Δ%, less than or equal to −0.1 Δ% and greater than or equal to −0.3 Δ%, or even less than or equal to −0.1 Δ% and greater than or equal to −0.2 Δ%. The above ranges include all subranges within the explicitly disclosed ranges as well as ranges formed from any combination of the endpoints thereof.

In the embodiments described herein, the core portion 102 comprises a core absolute relative refractive index Δ_{Cabs} defined as |(Δ_{Cmax})−(Δ_{Cmin})|(i.e., the absolute value of ((Δ_{Cmax})−(Δ_{Cmin}))). In the embodiments described herein, the core absolute relative refractive index Δ_{Cabs} of the core portion 102 may be greater than or equal to 0.85 Δ% and less than or equal to 1.3 Δ% to achieve the desired bandwidth in the multimode optical fiber 100. In embodiments, the core absolute relative refractive index Δ_{Cabs} may be greater than or equal to 0.85 Δ% and less than or equal to 1.3 Δ%, greater than or equal to 0.85 Δ% and less than or equal to 1.2 Δ%, greater than or equal to 0.85 Δ% and less than or equal to 1.1 Δ%, greater than or equal to 0.85 Δ% and less than or equal to 1 Δ%, greater than or equal to 0.85 Δ% and less than or equal to 0.9 Δ%, greater than or equal to 0.9 Δ% and less than or equal to 1.3 Δ%, greater than or equal to 0.9 Δ% and less than or equal to 1.2 Δ%, greater than or equal to 0.9 Δ% and less than or equal to 1.1 Δ%, greater than or equal to 0.9 Δ% and less than or equal to 1 Δ%, greater than or equal to 1 Δ% and less than or equal to 1.3 Δ%, greater than or equal to 1 Δ% and less than or equal to 1.2 Δ%, greater than or equal to 1 Δ% and less than or equal to 1.1 Δ%, greater than or equal to 1.1 Δ% and less than or equal to 1.3 Δ%, greater than or equal to 1.1 Δ% and less than or equal to 1.2 Δ%, or greater than or equal to 1.2 Δ% and less than or equal to 1.3 Δ%. The above ranges include all subranges within the explicitly disclosed ranges as well as ranges formed from any combination of the endpoints thereof.

In the embodiments of the multimode optical fibers 100 described herein, the core portion 102 comprises silica glass (SiO₂) intentionally down-doped with fluorine. It has been determined that doping the core portion 102 with fluorine lowers the overall refractive index of the multimode optical fiber 100 and, in turn, reduces the attenuation of the multimode optical fiber 100. In particular, the maximum relative refractive index of the core portion 102 can be reduced to less than 1 Δ% while still enabling an α-profile with a desired α-value as well as a desirable absolute relative refractive index in the core portion to facilitate multimode propagation and relatively high bandwidths. In particular, the inclusion of fluorine in the core portion 102 of the multimode optical fiber 100 reduces the sensitivity of the bandwidth of the optical fiber to variations in wavelength. In that regard, it has been found that silica-based glass doped with fluorine has a lower chromatic dispersion coefficient which, in turn, reduces the sensitivity of the α-value of the glass to changes in wavelength, providing for higher bandwidths over a broader range of operating wavelengths.

In embodiments, the silica-based glass of the core portion 102 may be co-doped with an up-dopant and a down-dopant. For example, in embodiments, the core portion 102 of the multimode optical fiber 100 may be doped with both GeO₂ and fluorine. In these embodiments, forming the multimode optical fiber 100 such that the core portion 102, the depressed index trench portion 104, and the outer cladding portion 108 all contain fluorine may reduce the amount of GeO₂ needed in the core portion 102 to achieve the desired optical characteristics of the multimode optical fiber 100. Including both GeO₂ and fluorine in the core portion 102 of the multimode optical fiber 100 may also enhance the ability to “tune” the relative refractive index profile of the core portion 102 to achieve the desired α-profile. In particular, relatively large concentrations of GeO₂ added to silica glass result in relatively small changes in the index of refraction of the silica glass. In contrast, relatively small concentrations of fluorine added to silica glass result in relatively larger changes in the index of refraction of the silica glass. As such, additions of fluorine may be used to generally obtain the desired shape of the α-profile in the core portion 102 while additions of GeO₂ may be used to fine-tune the α-profile of the core portion 102. In these embodiments, the maximum concentration of GeO₂ in the core portion 102 of the multimode optical fiber 100 may be greater than 0 wt % and less than or equal to 20.5 wt %. In embodiments, the maximum concentration of GeO₂ in the core portion 102 of the multimode optical fiber 100 may be greater than 0 wt % and less than or equal to 20 wt %, greater than 0 wt % and less than or equal to 19 wt %, greater than 0 wt % and less than or equal to 18 wt %, greater than 0 wt % and less than or equal to 17 wt %, greater than 0 wt % and less than or equal to 16 wt %, greater than 0 wt % and less than or equal to 15 wt %, greater than 0 wt % and less than or equal to 14 wt %, greater than 0 wt % and less than or equal to 13 wt %, greater than 0 wt % and less than or equal to 12 wt %, greater than 0 wt % and less than or equal to 11 wt %, greater than 0 wt % and less than or equal to 10 wt %, greater than 0 wt % and less than or equal to 9 wt %, greater than 0 wt % and less than or equal to 8 wt %, greater than 0 wt % and less than or equal to 7 wt %, greater than 0 wt % and less than or equal to 6 wt %, greater than 0 wt % and less than or equal to 5 wt %, greater than 0 wt % and less than or equal to 4 wt %, greater than 0 wt % and less than or equal to 3 wt %, greater than 0 wt % and less than or equal to 2 wt %, or even greater than 0 wt % and less than or equal to 1 wt %. The above ranges include all subranges within the explicitly disclosed ranges as well as ranges formed from any combination of the endpoints thereof.

As noted herein, in embodiments, the core portion 102 of the multimode optical fiber 100 also comprises fluorine in addition to GeO₂. That is, in embodiments, the core portion 102 may comprise silica-based glass doped with both GeO₂ and fluorine. In these embodiments, the maximum concentration of fluorine in the core portion 102 is greater than 0 wt % and less than or equal to 7.5 wt % such that the maximum relative refractive index Δ_{Cmax} of the core portion 102 is greater than 0 Δ% and less than or equal to 0.85 Δ% at or proximate the centerline C_{L} of the multimode optical fiber 100 and the minimum relative refractive index Δ_{Cmin} of the core portion 102 is less than Δ_{Cmax} and less than 0 Δ% at the radius rᵢ of the core portion 102. In such embodiments, the maximum concentration of fluorine in the core portion 102 may be greater than or equal to 0.5 wt % and less than or equal to 7.5 wt %, greater than or equal to 1.0 wt % and less than or equal to 7.5 wt %, greater than or equal to 1.5 wt % and less than or equal to 7.5 wt %, greater than or equal to 2.0 wt % and less than or equal to 7.5 wt %, greater than or equal to 2.5 wt % and less than or equal to 7.5 wt %, greater than or equal to 3.0 wt % and less than or equal to 7.5 wt %, greater than or equal to 3.5 wt % and less than or equal to 7.5 wt %, greater than or equal to 4.0 wt % and less than or equal to 7.5 wt %, greater than or equal to 4.5 wt % and less than or equal to 7.5 wt %, greater than or equal to 5.0 wt % and less than or equal to 7.5 wt %, greater than or equal to 5.5 wt % and less than or equal to 7.5 wt %, greater than or equal to 6.0 wt % and less than or equal to 7.5 wt %, greater than or equal to 6.5 wt % and less than or equal to 7.5 wt %, or even greater than or equal to 7.0 wt % and less than or equal to 7.5 wt %. The above ranges include all subranges within the explicitly disclosed ranges as well as ranges formed from any combination of the endpoints thereof.

In embodiments in which the core portion 102 of the optical fiber comprises both GeO₂ and fluorine, the concentration of GeO₂ in the core portion 102 may be graded from at or proximate to the centerline line C_{L} of the core portion 102 to the radius r₁ of the core portion 102 to achieve the parabolic shape of the α-profile of the core portion 102. Specifically, the concentration of GeO₂ in the core portion 102 may be a maximum at or proximate the centerline C_{L} of the core portion 102 and decreases from the maximum in the outward radial direction (i.e., in the direction of the radius r₁) relative to the centerline C_{L}. In embodiments, the concentration of GeO₂ in the core portion 102 may be a minimum at the radius r₁ of the core portion 102. In embodiments, the concentration of GeO₂ in the core portion 102 may be a minimum between the centerline C_{L} of the core portion and the radius r₁ of the core portion 102.

In embodiments where the core portion 102 comprises the down-dopant fluorine in combination with the up-dopant GeO₂, and the concentration of GeO₂ in the core portion 102 is graded from a maximum at or proximate the centerline C_{L} of the core portion 102, the concentration of fluorine in the core portion 102 may be graded in the core portion 102 to achieve the parabolic shape of the α-profile of the core portion 102. In embodiments, the concentration of fluorine in the core portion 102 may be a minimum at or proximate the centerline C_{L} of the core portion 102 and increases from the minimum in the outward radial direction (i.e., in the direction of the radius r₁) relative to the centerline C_{L}. In embodiments, the concentration of fluorine in the core portion 102 may be a minimum at or proximate the centerline C_{L} of the core portion 102 and increases from the minimum in the outward radial direction (i.e., in the direction of the radius r₁) starting at a point between the centerline C_{L} of the core portion 102 and the radius rᵢ of the core portion 102. The minimum of the concentration of fluorine in the core portion 102 may be zero or a non-zero amount. In embodiments, a radial distance between the point from which the concentration of fluorine starts to increase and the radial position rᵢ may be greater than or equal to 1 μm, greater than or equal to 2 μm, greater than or equal to 3 μm, greater than or equal to 4 μm, greater than or equal to 5 μm, greater than or equal to 10 μm, greater than or equal to 15 μm, greater than or equal to 20 μm, greater than or equal to 25 μm, greater than or equal to 30 μm, or greater. In embodiments, such radial distance may correspond or substantially correspond to the entire radius r₁, such as in the case where the concentration of fluorine in the core portion 102 may be a minimum at or proximate the centerline C_{L} of the core portion 102 and increases from the minimum in the outward radial direction (i.e., in the direction of the radius r₁) relative to the centerline C_{L}. In embodiments, the concentration of fluorine in the core portion 102 may be a maximum at the radius r₁ of the core portion 102.

In embodiments where the core portion 102 comprises the down-dopant fluorine in combination with the up-dopant GeO₂, the concentration of GeO₂ may be substantially uniform throughout the core portion 102 (i.e., the concentration of GeO₂ in the core portion does not vary by more than +/−2 wt % between the centerline C_{L}, of the core portion 102 and the radius r₁ of the core portion 102). However, to achieve the parabolic shape of the α-profile of the core portion 102, the concentration of fluorine in the core portion 102 may be graded from at or proximate to the centerline line C_{L} of the core portion 102 to the radius r₁ of the core portion 102. Specifically, the concentration of fluorine in the core portion 102 may be a minimum at or proximate the centerline C_{L} of the core portion 102 and increases from the minimum in the outward radial direction (i.e., in the direction of the radius r₁) relative to the centerline C_{L}. In embodiments, the concentration of fluorine in the core portion 102 may be a maximum at the radius r₁ of the core portion 102.

In embodiments where the core portion 102 comprises the down-dopant fluorine in combination with the up-dopant GeO₂, the concentration of fluorine may be substantially uniform throughout the core portion 102 (i.e., the concentration of fluorine in the core portion does not vary by more than +/−0.25 wt % between the centerline C_{L} of the core portion 102 and the radius r₁ of the core portion 102). However, to achieve the parabolic shape of the α-profile of the core portion 102, the concentration of GeO₂ in the core portion 102 may be graded from at or proximate to the centerline line C_{L} of the core portion 102 to the radius r₁ of the core portion 102. Specifically, the concentration of GeO₂ in the core portion 102 may be a maximum at or proximate the centerline CI, of the core portion 102 and decreases from the maximum in the outward radial direction (i.e., in the direction of the radius r₁) relative to the centerline C_{L}. In embodiments, the concentration of GeO₂ in the core portion 102 may be a minimum at the radius r₁ of the core portion 102. In embodiments, the concentration of GeO₂ in the core portion 102 may be a minimum between the centerline C_{L} of the core portion 102 and the radius r₁ of the core portion 102.

In embodiments, the core portion 102 may be free or substantially free of any up-dopants, such as GeO₂, for example. That is, in embodiments, the core portion 102 may comprise silica-based glass down-doped with fluorine. In some of these embodiments, the core portion 102 may comprise silica-based glass down-doped with fluorine without containing any other dopants. In these embodiments, the maximum concentration of fluorine in the core portion 102 is greater than 0 wt % and less than or equal to 7.5 wt % such that the core maximum relative refractive index Δ_{Cmax} of the core portion 102 is less than or equal to 0 Δ% and greater than or equal to −0.1 Δ% at or proximate the centerline C_{L} of the multimode optical fiber and the core minimum relative refractive index Δ_{Cmin} of the core portion 102 is less than Δ_{Cmax} and less than 0 Δ% at the radius r₁ of the core portion 102. In such embodiments, the maximum concentration of fluorine in the core portion may be greater than or equal to 0.5 wt % and less than or equal to 7.5 wt %, greater than or equal to 1.0 wt % and less than or equal to 7.5 wt %, greater than or equal to 1.5 wt % and less than or equal to 7.5 wt %, greater than or equal to 2.0 wt % and less than or equal to 7.5 wt %, greater than or equal to 2.5 wt % and less than or equal to 7.5 wt %, greater than or equal to 3.0 wt % and less than or equal to 7.5 wt %, greater than or equal to 3.5 wt % and less than or equal to 7.5 wt %, greater than or equal to 4.0 wt % and less than or equal to 7.5 wt %, greater than or equal to 4.5 wt % and less than or equal to 7.5 wt %, greater than or equal to 5.0 wt % and less than or equal to 7.5 wt %, greater than or equal to 5.5 wt % and less than or equal to 7.5 wt %, greater than or equal to 6.0 wt % and less than or equal to 7.5 wt %, greater than or equal to 6.5 wt % and less than or equal to 7.5 wt %, or even greater than or equal to 7.0 wt % and less than or equal to 7.5 wt %. The above ranges include all subranges within the explicitly disclosed ranges as well as ranges formed from any combination of the endpoints thereof.

In embodiments where the core portion 102 comprises the down-dopant fluorine without containing the up-dopant GeO₂, the concentration of fluorine in the core portion 102 may be graded from at or proximate to the centerline line C_{L} of the core portion 102 to the radius r₁ of the core portion 102 to achieve the parabolic shape of the α-profile of the core portion 102. Specifically, the concentration of fluorine in the core portion 102 may be a minimum at or proximate the centerline C_{L} of the core portion 102 and increases from the minimum in the outward radial direction (i.e., in the direction of the radius r₁) relative to the centerline C_{L}. In embodiments, the concentration of fluorine in the core portion 102 may be a maximum at the radius r₁ of the core portion 102.

As described herein, the depressed index trench portion 104 has a radial width w₂ defined by r₂-r₁. In the embodiments described herein, the radial width w₂ of the depressed index trench portion 104 is greater than or equal to 2 μm and less than or equal to 15 μm. In embodiments, the radial width w₂ of the depressed index trench portion 104 is greater than or equal to 2 μm and less than or equal to 10 μm or even greater than or equal to 4 μm and less than or equal to 10 μm. The above ranges include all subranges within the explicitly disclosed ranges as well as ranges formed from any combination of the endpoints thereof.

The radial width w₂ of the depressed index trench portion 104 may be interrelated with the minimum relative refractive index Δ_{Tmin} of the depressed index trench portion 104.

Specifically, the depressed index trench portion 104 may have a trench volume volume V_{T} defined as:

$${V}_{T} = \vert 2 {\int }_{{r}_{Trench , inner}}^{{r}_{Trench , outer}} {Δ}_{Trench} ( r ) rdr \vert \qquad ( 4 )$$

where r_{Trench,inner} is the inner radius of the trench region of the refractive index profile, r_{Trench,outer} is the outer radius of the trench region of the refractive index profile, Δ_{Trench}(r) is the relative refractive index of the trench region of the refractive index profile, and r is radial position in the fiber. Trench volume will be expressed herein in units of % Δmicron², % Δ-micron², % A-μm², % Δμm², or %-micron², whereby these units can be used interchangeably herein.

In embodiments described herein, the trench volume V_{T} may be greater than or equal to 40%-μm² and less than or equal to 300%-μm². In embodiments, the trench volume V_{T} may be greater than or equal to 50%-μm² and less than or equal to 280%-μm², greater than or equal to 75%-μm² and less than or equal to 280%-μm², greater than or equal to 100%-μm² and less than or equal to 280%-μm², greater than or equal to 125%-μm² and less than or equal to 280%-μm², greater than or equal to 150%-μm² and less than or equal to 280%-μm², greater than or equal to 175%-μm² and less than or equal to 280%-μm², greater than or equal to 200%-μm² and less than or equal to 280%-μm², greater than or equal to 225%-μm² and less than or equal to 280%-μm², or even greater than or equal to 250%-μm² and less than or equal to 280%-μm². The above ranges include all subranges within the explicitly disclosed ranges as well as ranges formed from any combination of the endpoints thereof.

In embodiments of the multi-mode optical fibers described herein, the depressed index trench portion 104 has a minimum relative refractive index Δ_{Tmin} greater than or equal to −1.50 Δ% and less than or equal to −0.20 Δ%. In embodiments, the depressed index trench portion may have a minimum relative refractive index Δ_{Tmin} greater than or equal to −1.30 Δ% and less than or equal to −0.20 Δ%, greater than or equal to −1.20 Δ% and less than or equal to −0.20 Δ%, greater than or equal to −1.10 Δ% and less than or equal to −0.20 Δ%, greater than or equal to −1.00 Δ% and less than or equal to −0.20 Δ%, greater than or equal to −0.90 Δ% and less than or equal to −0.20 Δ%, greater than or equal to −0.80 Δ% and less than or equal to −0.20 Δ%, greater than or equal to −0.70 Δ% and less than or equal to −0.20 Δ%, greater than or equal to −0.60 Δ% and less than or equal to −0.20 Δ%, or even greater than or equal to −0.50 Δ% and less than or equal to −0.20 Δ%. The above ranges include all subranges within the explicitly disclosed ranges as well as ranges formed from any combination of the endpoints thereof.

In the embodiments described herein, the depressed index trench portion 104 comprises silica-based glass down-doped with fluorine. In embodiments, the maximum concentration of fluorine in the depressed index trench portion 104 is greater than 0 wt % and less than or equal to 7.5 wt % such that the minimum relative refractive index Δ_{Tmin} of the depressed index trench portion 104 is less than 0 Δ%. In embodiments, the maximum concentration of fluorine in the depressed index trench portion 104 may be greater than or equal to 0.5 wt % and less than or equal to 7.5 wt %, greater than or equal to 1.0 wt % and less than or equal to 7.5 wt %, greater than or equal to 1.5 wt % and less than or equal to 7.5 wt %, greater than or equal to 2.0 wt % and less than or equal to 7.5 wt %, greater than or equal to 2.5 wt % and less than or equal to 7.5 wt %, greater than or equal to 3.0 wt % and less than or equal to 7.5 wt %, greater than or equal to 3.5 wt % and less than or equal to 7.5 wt %, greater than or equal to 4.0 wt % and less than or equal to 7.5 wt %, greater than or equal to 4.5 wt % and less than or equal to 7.5 wt %, greater than or equal to 5.0 wt % and less than or equal to 7.5 wt %, greater than or equal to 5.5 wt % and less than or equal to 7.5 wt %, greater than or equal to 6.0 wt % and less than or equal to 7.5 wt %, greater than or equal to 6.5 wt % and less than or equal to 7.5 wt %, or even greater than or equal to 7.0 wt % and less than or equal to 7.5 wt %. The above ranges include all subranges within the explicitly disclosed ranges as well as ranges formed from any combination of the endpoints thereof.

As described herein, the shelf portion 106 has a radial width w₃ defined by r₃−r₂. The radial width w₃ of the shelf portion 106 is greater than 0 μm and less than or equal to 10 μm to facilitate operation of the multimode optical fiber 100 at relatively high bandwidths. In embodiments, the radial width w₃ of the shelf portion 106 is greater than 0 μm and less than or equal to 9 μm, greater than 0 μm and less than or equal to 8 μm, greater than 0 μm and less than or equal to 7 μm, greater than 0 μm and less than or equal to 6 μm, greater than 0 μm and less than or equal to 5 μm, greater than 0 μm and less than or equal to 4 μm, greater than 0 μm and less than or equal to 3 μm, or even greater than 0 μm and less than or equal to 2 μm. The above ranges include all subranges within the explicitly disclosed ranges as well as ranges formed from any combination of the endpoints thereof.

In embodiments of the multi-mode optical fibers described herein, the shelf portion 106 has a maximum relative refractive index Δ_{Smax} greater than or equal to −0.4 Δ% and less than or equal to 0 Δ%. In embodiments, the shelf portion 106 may have a maximum relative refractive index Δ_{Smax} greater than or equal to −0.3 Δ% and less than or equal to 0 Δ%, greater than or equal to 0.2 Δ% and less than or equal to 0 Δ%, or even greater than or equal to 0.10 Δ% and less than or equal to 0 Δ%. The above ranges include all subranges within the explicitly disclosed ranges as well as ranges formed from any combination of the endpoints thereof.

In embodiments, the shelf portion 106 of the multimode optical fiber 100 comprises pure silica glass. However, in other embodiments, the shelf portion 106 may be down-doped with fluorine. In embodiments where the shelf portion 106 comprises silica-based glass down-doped with fluorine, the maximum concentration of fluorine in the shelf portion 106 may be greater than 0 wt % and less than or equal to 1.4 wt %. In embodiments, the maximum concentration of fluorine in the shelf portion 106 may be greater than or equal to 0 wt % and less than or equal to 1.3 wt %, greater than or equal to 0 wt % and less than or equal to 1.2 wt %, greater than or equal to 0 wt % and less than or equal to 1.1 wt %, greater than or equal to 0 wt % and less than or equal to 1 wt %, greater than or equal to 0 wt % and less than or equal to 0.9 wt %, greater than or equal to 0 wt % and less than or equal to 0.8 wt %, greater than or equal to 0 wt % and less than or equal to 0.7 wt %, greater than or equal to 0 wt % and less than or equal to 0.6 wt %, greater than or equal to 0 wt % and less than or equal to 0.5 wt %, greater than or equal to 0 wt % and less than or equal to 0.4 wt %, greater than or equal to 0 wt % and less than or equal to 0.3 wt %, greater than or equal to 0 wt % and less than or equal to 0.2 wt %, or greater than or equal to 0 wt % and less than or equal to 0.1 wt %. The above ranges include all subranges within the explicitly disclosed ranges as well as ranges formed from any combination of the endpoints thereof.

Still referring to FIGS. 1 and 2, the radial width w₄ (e.g., r₄−r₃) of the outer cladding portion 108 is greater than or equal to 10 μm and less than or equal to 40 μm. In embodiments, the radial width w₄ of the outer cladding portion is greater than or equal to 15 μm and less than or equal to 35 μm or even greater than or equal to 20 μm and less than or equal to 35 μm. In embodiments, the outer cladding portion 108 may generally comprise a radial width w₄ such that the outer diameter (i.e., 2r₄) of the multimode optical fiber is as described herein (e.g., r₄ is 62.5 μm; 2r₄₌₁₂₅ μm).

In embodiments of the multi-mode optical fibers described herein, the outer cladding portion 108 has a relative refractive index Δ_{OC} greater than or equal to −1.5 Δ% and less than or equal to −0.2 Δ%. In embodiments, the outer cladding portion 108 may have a relative refractive index Δ_{OC} greater than or equal to −1.4 Δ% and less than or equal to −0.2 Δ%, greater than or equal to −1.3 Δ% and less than or equal to −0.2 Δ%, greater than or equal to −1.2 Δ% and less than or equal to −0.2 Δ%, greater than or equal to −1.1 Δ% and less than or equal to −0.2 Δ%, greater than or equal to −1.0 Δ% and less than or equal to −0.2 Δ%, greater than or equal to −0.9 Δ% and less than or equal to −0.2 Δ%, greater than or equal to −0.8 Δ% and less than or equal to −0.2 Δ%, greater than or equal to −0.7 Δ% and less than or equal to −0.2 Δ%, greater than or equal to −0.6 Δ% and less than or equal to −0.2 Δ%, or even greater than or equal to −0.5 Δ% and less than or equal to −0.2 Δ%. In embodiments, the outer cladding portion 108 may have a relative refractive index Δ_{OC} greater than or equal to −1.4 Δ% and less than or equal to −0.4 Δ%, greater than or equal to −1.3 Δ% and less than or equal to −0.4 Δ%, greater than or equal to −1.2 Δ% and less than or equal to −0.4 Δ%, greater than or equal to −1.1 Δ% and less than or equal to −0.4 Δ%, greater than or equal to −1.0 Δ% and less than or equal to −0.4 Δ%, greater than or equal to −0.9 Δ% and less than or equal to −0.4 Δ%, greater than or equal to −0.8 Δ% and less than or equal to −0.4 Δ%, greater than or equal to −0.7 Δ% and less than or equal to −0.4 Δ%, or even greater than or equal to −0.6 Δ% and less than or equal to −0.4 Δ%. The above ranges include all subranges within the explicitly disclosed ranges as well as ranges formed from any combination of the endpoints thereof.

As noted herein, the outer cladding portion 108 may comprise silica-based glass down-doped with fluorine. In embodiments, the concentration of fluorine in the outer cladding portion 108 is greater than 0 wt % and less than or equal to 7.5 wt %. In embodiments, the concentration of fluorine in the outer cladding portion 108 may be greater than or equal to 0.5 wt % and less than or equal to 7.5 wt %, greater than or equal to 1.0 wt % and less than or equal to 7.5 wt %, greater than or equal to 1.5 wt % and less than or equal to 7.5 wt %, greater than or equal to 2.0 wt % and less than or equal to 7.5 wt %, greater than or equal to 2.5 wt % and less than or equal to 7.5 wt %, greater than or equal to 3.0 wt % and less than or equal to 7.5 wt %, greater than or equal to 3.0 wt % and less than or equal to 5 wt %, greater than or equal to 3.5 wt % and less than or equal to 7.5 wt %, greater than or equal to 4.0 wt % and less than or equal to 7.5 wt %, greater than or equal to 4.5 wt % and less than or equal to 7.5 wt %, greater than or equal to 5.0 wt % and less than or equal to 7.5 wt %, greater than or equal to 5.5 wt % and less than or equal to 7.5 wt %, greater than or equal to 6.0 wt % and less than or equal to 7.5 wt %, greater than or equal to 6.5 wt % and less than or equal to 7.5 wt %, or even greater than or equal to 7.0 wt % and less than or equal to 7.5 wt %. The above ranges include all subranges within the explicitly disclosed ranges as well as ranges formed from any combination of the endpoints thereof.

As described herein, each of the core portion 102, the depressed index trench portion 104, and the outer cladding portion 108 comprise silica-based glass doped with fluorine. The shelf portion 106 may optionally include silica-based glass doped with fluorine. The relative amounts of fluorine in each portion of the multimode optical fiber 100 may be selected to achieve the desired relative refractive index profile in the multimode optical fiber. For example, the relative amounts of fluorine in each portion of the multimode optical fiber may be selected such that the multimode optical fiber comprises, without limitation, a core portion 102 comprising an α-profile with an α-value greater than or equal to 1.75 and less than or equal to 2.25, an absolute relative refractive index Δ_{Cabs} greater than or equal to 0.85 Δ% and less than or equal to 1.3 Δ%, a maximum relative refractive index Δ_{Cmax} less than or equal to 0.85 Δ% and greater than or equal to −0.1 Δ%, and a minimum relative refractive index Δ_{Cmin} less than 0 Δ%.

In the embodiments of the multimode optical fibers described herein, the optical fibers can be drawn from a finished preform and, thereafter, coated with, for example, conventional primary and secondary urethane acrylate coatings.

The various embodiments of the multimode optical fiber 100 described herein have improved bend performance due to the incorporation of the depressed index trench portion 104 within the cladding portion 103. In embodiments, the macrobend loss using restricted mode launch (core only) of the multimode optical fibers described herein is less than or equal to 0.5 dB/(2 turns around a 15 mm diameter mandrel) at operating wavelengths of 850 nm and/or 1300 nm. That is, the macrobend loss is less than or equal to 0.5 dB/(2 turns around a 15 mm diameter mandrel) at each of these wavelengths when tested according to the macrobend test described herein. In embodiments, the macrobend loss may be less than or equal to 0.4 dB/(2 turns around a 15 mm diameter mandrel), less than or equal to 0.3 dB/(2 turns around a 15 mm diameter mandrel), less than or equal to 0.2 dB/(2 turns around a 15 mm diameter mandrel), less than or equal to 0.1 dB/(2 turns around a 15 mm diameter mandrel), less than or equal to 0.05 dB/(2 turns around a 15 mm diameter mandrel), or even less than or equal to 0.025 dB/(2 turns around a 15 mm diameter mandrel) at operating wavelengths of 850 nm and/or 1300 nm. In embodiments, the macrobend loss is less than or equal to 0.09 dB/(2 turns around a 15 mm diameter mandrel), less than or equal to 0.08 dB/(2 turns around a 15 mm diameter mandrel), less than or equal to 0.06 dB/(2 turns around a 15 mm diameter mandrel), less than or equal to 0.04 dB/(2 turns around a 15 mm diameter mandrel), less than or equal to 0.02 dB/(2 turns around a 15 mm diameter mandrel), or even less than or equal to 0.01 dB/(2 turns around a 15 mm diameter mandrel) at an operating wavelength of 850 nm.

In the embodiments described herein, the multimode optical fibers have a bandwidth greater than or equal to 0.05 GHz-km for each wavelength within a wavelength operating window having a width greater than 100 nm. The wavelength operating window may be centered on at least one wavelength within an operating wavelength range from about 820 nm to about 1310 nm. For example, in an embodiment, the width of the wavelength operating window may be 200 nm and the wavelength operating window may be centered at an operating wavelength of 850 nm (i.e., the wavelength operating window extends from 750 nm to 950 nm). In this example, multimode optical fiber will have a bandwidth of greater than 0.05 GHZ-km for wavelengths of light from about 750 nm to about 950 nm propagating within the optical fiber. In embodiments, the wavelength operating window may be centered on at least one of 850 nm, 953 nm, 980 nm, 1060 nm, and 1310 nm. In embodiments, the multimode optical fibers have a bandwidth greater than 0.05 GHz-km to less than or equal to 10 GHz-km within the wavelength operating window. In embodiments, the wavelength operating window may have a width greater than about 150 nm or even greater than about 200 nm.

In embodiments, the multimode optical fibers have an overfilled launch (OFL) bandwidth of greater than or equal to 0.050 GHz-km and less than or equal to 10.000 GHz-km. In embodiments, the OFL bandwidth of the multimode optical fibers may be greater than or equal to 0.050 GHz-km and less than or equal to 9.500 GHz-km, greater than or equal to 0.050 GHz-km and less than or equal to 9.000 GHz-km, greater than or equal to 0.050 GHz-km and less than or equal to 8.500 GHz-km, greater than or equal to 0.050 GHz-km and less than or equal to 8.000 GHz-km, greater than or equal to 0.050 GHz-km and less than or equal to 7.500 GHz-km, greater than or equal to 0.050 GHz-km and less than or equal to 7.00 GHz-km, greater than or equal to 0.050 GHz-km and less than or equal to 6.500 GHz-km, greater than or equal to 0.050 GHz-km and less than or equal to 6.00 GHz-km, greater than or equal to 0.050 GHz-km and less than or equal to 5.500 GHz-km, greater than or equal to 0.050 GHz-km and less than or equal to 5.00 GHz-km, or even greater than or equal to 0.050 GHz-km and less than or equal to 4.500 GHz-km. The above ranges include all subranges within the explicitly disclosed ranges as well as ranges formed from any combination of the endpoints thereof.

In embodiments, the multimode optical fibers have an effective modal bandwidth (EMB) of greater than or equal to 0.020 GHz-km and less than or equal to 10.000 GHz-km according to IEC 60793-1-49. In embodiments, the EMB of the multimode optical fibers may be greater than or equal to 0.020 GHz-km and less than or equal to 9.500 GHz-km, greater than or equal to 0.020 GHz-km and less than or equal to 9.000 GHz-km, greater than or equal to 0.020 GHz-km and less than or equal to 8.500 GHz-km, greater than or equal to 0.020 GHZ-km and less than or equal to 8.000 GHz-km, greater than or equal to 0.020 GHz-km and less than or equal to 7.500 GHz-km, greater than or equal to 0.020 GHz-km and less than or equal to 7.00 GHz-km, greater than or equal to 0.020 GHz-km and less than or equal to 6.500 GHz-km, greater than or equal to 0.020 GHz-km and less than or equal to 6.00 GHz-km, greater than or equal to 0.020 GHz-km and less than or equal to 5.500 GHz-km, greater than or equal to 0.020 GHz-km and less than or equal to 5.00 GHz-km, or even greater than or equal to 0.020 GHz-km and less than or equal to 4.500 GHz-km. The above ranges include all subranges within the explicitly disclosed ranges as well as ranges formed from any combination of the endpoints thereof.

In embodiments, the multimode optical fibers have a numerical aperture of greater than or equal to 0.150 and less than or equal to 0.250. In embodiments, the multimode optical fibers may have a numerical aperture greater than or equal to 0.175 and less than or equal to 0.225, greater than or equal to 0.185 and less than or equal to 0.220, or even greater than or equal to 0.190 and less than or equal to 0.215. The above ranges include all subranges within the explicitly disclosed ranges as well as ranges formed from any combination of the endpoints thereof.

In embodiments, the multimode optical fibers have an attenuation at a wavelength of 1310 nm of less than or equal to 0.25 db/km. In embodiments, the multimode optical fibers have an attenuation or less than or equal to 0.20 db/km.

The multimode optical fibers described herein may be produced by initially forming an optical fiber preform having a preform core portion, a preform depressed index trench portion, a preform shelf portion, and a preform outercladding portion with the same structural arrangement and composition as the corresponding core portion, depressed index trench portion, shelf portion, and outercladding portion of the multimode optical fibers described herein. That is, the optical fiber preform is effectively a large-scale version of the multimode optical fiber. Techniques for forming the optical fiber preform include, without limitation, plasma-enhanced chemical vapor deposition (PCVD), modified chemical vapor deposition (MCVD), and outside vapor deposition (OVD). Each of these techniques may be utilized to deposit silica-based glass doped with GeO₂ and/or fluorine to form an optical fiber preform having the structural arrangement and compositions as described herein. Thereafter, the optical fiber preform may be drawn to a multimode optical fiber having the composition and dimensions described herein for each of the core portion, depressed index trench portion, shelf portion, and outercladding portion using conventional drawing techniques for drawing an optical fiber from an optical fiber preform.

### EXAMPLES

The embodiments described herein will be further clarified by the following examples.

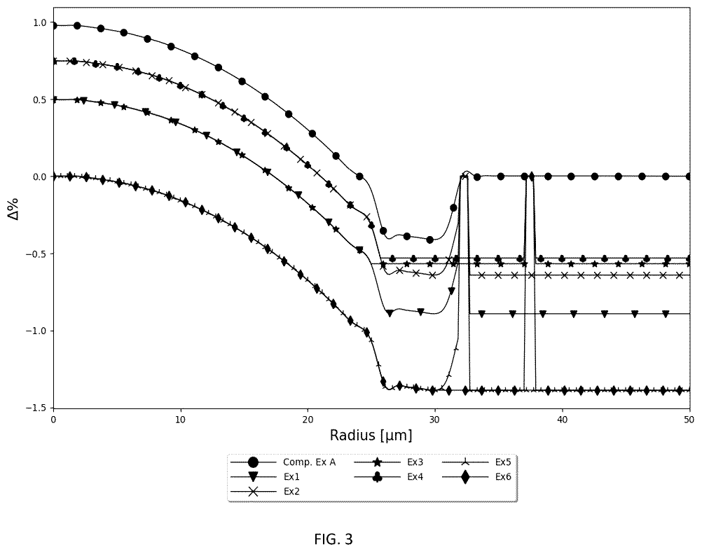

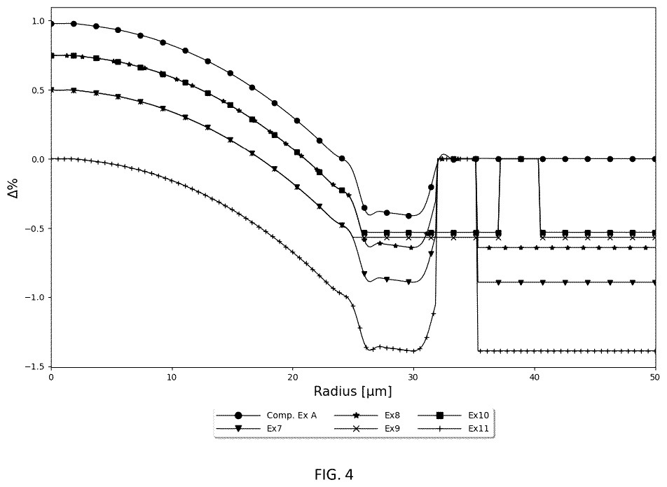

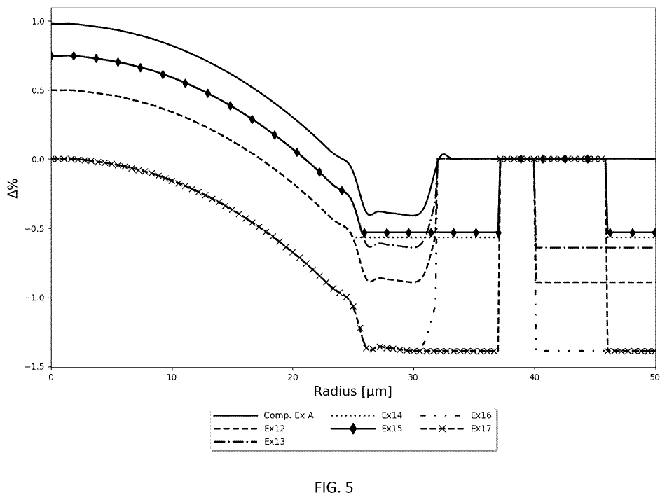

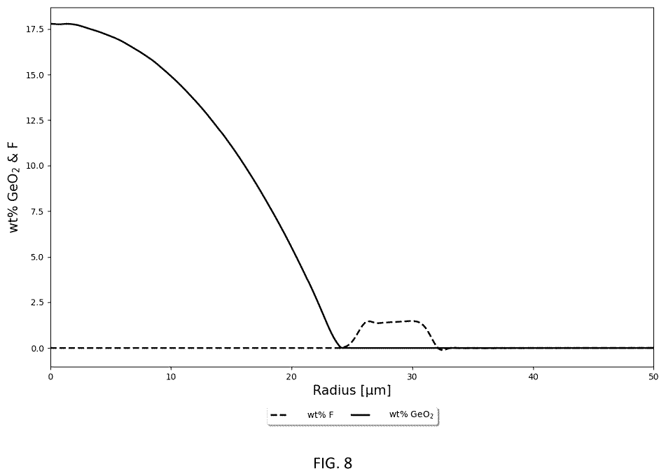

Multimode optical fibers were mathematically modeled to simulate the effect of different relative refractive index profiles on the properties (numerical aperture, attenuation, effective modal bandwidth, and overfilled launch bandwidth) of the fiber. Each of the multimode optical fibers was modeled with a core portion, a depressed index trench portion, a shelf portion, and an outer cladding portion. The multimode fibers were modeled with a core radius r₁ of 25 μm, an outer radius r₄ of 62.5 μm, and an α-profile with an α-value of 2.2. The core maximum relative refractive index Δ_{Cmax}, trench minimum relative refractive index Δ_{Tmin}, trench volume, and outer cladding relative refractive index Δ_{OC} were varied to simulate different concentrations of fluorine in the core portion, depressed index trench portion, and outer cladding portion, and different concentrations of GeO₂ in the core portion. In addition, the position (relative to the core portion) and radial width of the shelf portion were varied. A comparative example (Comp. Ex. A) was also modeled and simulated a conventional multimode optical fiber with a GeO₂ doped core portion (without fluorine in the core portion and without a shelf portion). The concentrations of GeO₂ and fluorine in the various portions of the modeled multimode optical fibers were calculated based on the core maximum relative refractive index Δ_{Cmax}, trench minimum relative refractive index Δ_{Tmin}, trench volume, and outer cladding relative refractive index Δ_{OC} of each modeled fiber. The concentrations of GeO₂ and fluorine in the various portions of the modeled multimode optical fibers and the properties (i.e., numerical aperture, attenuation, effective modal bandwidth, and overfilled launch bandwidth) of the modeled multimode optical fibers were calculated and are reported in Table 1, Table 2, and Table 3. The relative refractive index profiles of the modeled multimode optical fibers and the comparative multimode optical fiber are schematically depicted in FIGS. 3-6. The concentrations of GeO₂ and fluorine as a function of radius of select ones of the modeled multimode optical fibers are depicted in FIGS. 8-12.

TABLE 1

| Example | 1A | 1B | 1C | 2 | 3 | 4A | 4B | 4C |
|---|---|---|---|---|---|---|---|---|
| Max GeO₂ | 9.1 | 9.1 | 17.7 | 13.6 | 9.1 | 13.6 | 13.6 | 17.7 |
| in Core (wt %) | | | | | | | | |
| Max F in | 2.0 | 2.0 | 1.7 | 1.1 | 3.0 | 1.1 | 1.8 | 1.1 |
| Core (wt %) | | | | | | | | |
| Max F in | 3.2 | 3.2 | 3.2 | 2.3 | 2.0 | 1.9 | 1.9 | 1.9 |
| Trench (wt %) | | | | | | | | |
| Max F In | 0 | 0 | 0 | 0 | 0 | 0 | 0 | 0 |
| Shelf (wt %) | | | | | | | | |
| Max F in Outer | 3.2 | 3.2 | 3.2 | 2.3 | 2.0 | 1.9 | 1.9 | 1.9 |
| Cladding (wt %) | | | | | | | | |
| Δ_{Cmax} (Δ %) | 0.498 | 0.498 | 0.498 | 0.748 | 0.498 | 0.748 | 0.748 | 0.748 |
| α-value | 2.2 | 2.2 | 2.2 | 2.2 | 2.2 | 2.2 | 2.2 | 2.2 |
| Δ_{Tmin} (Δ %) | −0.89 | −0.89 | −0.89 | −0.64 | −0.57 | −0.53 | −0.53 | −0.53 |
| r₁ (μm) | 25 | 25 | 25 | 25 | 25 | 25 | 25 | 25 |
| r₂ (μm) | 31.9 | 31.9 | 31.9 | 31.9 | 37.1 | 37.1 | 37.1 | 37.1 |
| r₃ (μm) | 32.65 | 32.65 | 32.65 | 32.65 | 37.8 | 37.8 | 37.8 | 37.8 |
| r₄ (μm) | 62.5 | 62.5 | 62.5 | 62.5 | 62.5 | 62.5 | 62.5 | 62.5 |
| Δ_{OC} (Δ %) | −0.892 | −0.892 | −0.892 | −0.642 | −0.568 | −0.531 | −0.531 | −0.531 |
| Trench | 124.1 | 124.1 | 124.1 | 127.0 | 47.225 | 206.54 | 206.54 | 206.54 |
| Volume (Δ %-μm²) | | | | | | | | |
| NA_{C} | 0.202 | 0.202 | 0.202 | 0.202 | 0.195 | 0.208 | 0.208 | 0.208 |
| Attenuation | 0.175-0.19 | 0.175-0.19 | 0.175-0.19 | 0.183-0.19 | 0.175-0.19 | 0.183-0.19 | 0.183-0.19 | 0.183-0.19 |
| @ 1310 nm (dB/km) | | | | | | | | |
| 2 × 15 mm | 0.024 | 0.024 | 0.024 | 0.022 | 0.083 | 0.01 | 0.01 | 0.01 |
| 850 nm | | | | | | | | |
| Bend loss (dB) | | | | | | | | |
| 2 × 15 mm | 0.132 | 0.132 | 0.132 | 0.125 | 0.358 | 0.07 | 0.07 | 0.07 |
| 1300 nm | | | | | | | | |
| Bend loss (dB) | | | | | | | | |
| EM | 4.077 | 4.077 | 4.077 | 3.209 | 2.215 | 3.156 | 3.156 | 3.156 |
| Bandwidth (GHz-km) | | | | | | | | |
| OFL | 4.397 | 4.397 | 4.397 | 3.445 | 3.403 | 3.368 | 3.368 | 3.368 |
| Bandwidth (GHz-km) | | | | | | | | |

TABLE 2

| Example | 5A | 5B | 5C | 6 | 7 | 8 | 9 | 10 | 11 |
|---|---|---|---|---|---|---|---|---|---|
| Max GeO₂ | 0 | 9.1 | 17.7 | 0 | 9.1 | 13.6 | 9.1 | 13.6 | 0 |
| in Core (wt %) | | | | | | | | | |
| Max F in | 3.8 | 3.8 | 3.8 | 3.8 | 2.0 | 1.1 | 2.0 | 1.1 | 3.8 |
| Core (wt %) | | | | | | | | | |
| Max F in | 5.0 | 5.0 | 5.0 | 5 | 3.2 | 2.3 | 2.0 | 1.9 | 5.0 |
| Trench (wt %) | | | | | | | | | |
| Max F In | 0 | 0 | 0 | 0 | 0 | 0 | 0 | 0 | 0 |
| Shelf (wt %) | | | | | | | | | |
| Max F in Outer | 0 | 0 | 0 | 5 | 3.2 | 2.3 | 2.0 | 1.9 | 5.0 |
| Cladding (wt %) | | | | | | | | | |
| Δ_{Cmax} (Δ %) | 0 | 0 | 0 | 0 | 0.498 | 0.748 | 0.498 | 0.748 | 0 |
| α-value | 2.2 | 2.2 | 2.2 | 2.2 | 2.2 | 2.2 | 2.2 | 2.2 | 2.2 |
| Δ_{Tmin} (Δ %) | −1.39 | −1.39 | −1.39 | −1.39 | −0.89 | −0.64 | −0.57 | −0.53 | −1.39 |
| r₁ (μm) | 25 | 25 | 25 | 25 | 25 | 25 | 25 | 25 | 25 |
| r₂ (μm) | 31.9 | 31.9 | 31.9 | 37.1 | 31.9 | 31.9 | 37.1 | 37.1 | 31.9 |
| r₃ (μm) | 32.75 | 32.75 | 32.75 | 37.8 | 35.24 | 35.24 | 40.4 | 40.4 | 35.24 |
| r₄ (μm) | 62.5 | 62.5 | 62.5 | 62.5 | 62.5 | 62.5 | 62.5 | 62.5 | 62.5 |
| Δ_{OC} (Δ %) | −1.39 | −1.39 | −1.39 | −1.39 | −0.892 | −0.642 | −0.568 | −0.531 | −1.39 |
| Trench | 118.16 | 118.16 | 118.16 | 270.89 | 124.05 | 127.01 | 47.23 | 206.54 | 118.16 |
| Volume (Δ %-μm²) | | | | | | | | | |
| NA_{C} | 0.201 | 0.201 | 0.201 | 0.214 | 0.202 | 0.202 | 0.195 | 0.208 | 0.201 |
| Attenuation | 0.16-0.19 | 0.16-0.19 | 0.16-0.19 | 0.16-0.19 | 0.175-0.19 | 0.183-0.19 | 0.175-0.19 | 0.183-0.19 | 0.16-0.19 |
| @ 1310 nm (dB/km) | | | | | | | | | |
| 2 × 15 mm | 0.028 | 0.028 | 0.028 | 0.005 | 0.024 | 0.022 | 0.083 | 0.012 | 0.028 |
| 850 nm | | | | | | | | | |
| Bend loss (dB) | | | | | | | | | |
| 2 × 15 mm | 0.145 | 0.145 | 0.145 | 0.01 | 0.132 | 0.125 | 0.358 | 0.02 | 0.145 |
| 1300 nm | | | | | | | | | |
| Bend loss (dB) | | | | | | | | | |
| EM | 6.517 | 6.517 | 6.517 | 7.517 | 0.085 | 3.215 | 0.1 | 3.192 | 0.149 |
| Bandwidth (GHz-km) | | | | | | | | | |
| OFL | 6.904 | 6.904 | 6.904 | 6.668 | 2.032 | 3.489 | 2.006 | 3.47 | 0.141 |
| Bandwidth (GHz-km) | | | | | | | | | |

TABLE 3

| Example | 12 | 13 | 14 | 15 | 16 | 17 | 18 | 19 | Comp. A |
|---|---|---|---|---|---|---|---|---|---|
| Max GeO₂ | 9.1 | 13.6 | 9.1 | 13.6 | 0 | 0 | 13.6 | 0 | 17.8 |
| in Core (wt %) | | | | | | | | | |
| Max F in | 2.0 | 1.1 | 2.0 | 1.1 | 3.8 | 3.8 | 2.3 | 3.8 | 0.3* |
| Core (wt %) | | | | | | | | | |
| Max F in | 3.2 | 2.3 | 2 | 1.9 | 5 | 5 | 2.3 | 5.0 | 1.5 |
| Trench (wt %) | | | | | | | | | |
| Max F In | 0 | 0 | 0 | 0 | 0 | 0 | 0 | 0 | N/A |
| Shelf (wt %) | | | | | | | | | |
| Max F in Outer | 3.2 | 2.3 | 2.0 | 1.9 | 5.0 | 5.0 | 0.7 | 3.6 | 0 |
| Cladding (wt %) | | | | | | | | | |
| Δ_{Cmax} (Δ %) | 0.498 | 0.748 | 0.498 | 0.748 | 0 | 0 | 0.748 | 0 | 0.98 |
| α-value | 2.2 | 2.2 | 2.2 | 2.2 | 2.2 | 2.2 | 2.2 | 2.2 | 2.2 |
| Δ_{Tmin} (Δ %) | −0.892 | −0.642 | −0.568 | −0.531 | −1.39 | −1.39 | −0.64 | −1.39 | — |
| r₁ (μm) | 25 | 25 | 25 | 25 | 25 | 25 | 25 | 25 | 25 |
| r₂ (μm) | 31.9 | 31.9 | 37.1 | 37.1 | 31.9 | 37.1 | 31.9 | 37.1 | — |
| r₃ (μm) | 40.05 | 40.05 | 45.9 | 45.9 | 40.05 | 45.97 | 35.24 | 37.8 | — |
| r₄ (μm) | 62.5 | 62.5 | 62.5 | 62.5 | 62.5 | 62.5 | 62.5 | 62.5 | 62.5 |
| Δ_{OC} (Δ %) | −0.892 | −0.642 | −0.568 | −0.531 | −1.39 | −1.39 | −0.2 | −1.0 | — |
| Trench | 124.05 | 127.01 | 47.23 | 206.54 | 118.16 | 270.89 | 127.01 | 270.89 | — |
| Volume (Δ %-μm²) | | | | | | | | | |
| NA_{C} | 0.202 | 0.202 | 0.195 | 0.208 | 0.201 | 0.214 | 0.202 | 0.214 | — |
| Attenuation | 0.175-0.19 | 0.183-0.19 | 0.175-0.19 | 0.183-0.19 | 0.16-0.19 | 0.16-0.19 | — | — | 0.19 |
| @ 1310 nm (dB/km) | | | | | | | | | |
| 2 × 15 mm | 0.024 | 0.022 | 0.083 | 0.014 | 0.028 | 0.006 | 0.023 | 0.006 | — |
| 850 nm | | | | | | | | | |
| Bend loss (dB) | | | | | | | | | |
| 2 × 15 mm | 0.132 | 0.125 | 0.358 | 0.025 | 0.145 | 0.012 | 0.126 | 0.015 | — |
| 1300 nm | | | | | | | | | |
| Bend loss (dB) | | | | | | | | | |
| EM | 0.03 | 0.077 | 0.038 | 0.088 | 0.04 | 0.036 | — | — | — |
| Bandwidth (GHz-km) | | | | | | | | | |
| OFL | 0.737 | 1.978 | 0.801 | 1.966 | 0.069 | 0.063 | 3.478 | 6.638 | — |
| Bandwidth (GHz-km) | | | | | | | | | |

*The maximum fluorine concentration of 0.3 wt % in the core region in Comparative Example A is present at the radial position r₁ due to diffusion of fluorine from the depressed index trench portion. The core region of Comparative Example A is not intentionally doped with fluorine.

As indicated in Tables 1, 2, and 3, each of the modeled multimode optical fibers exhibited good optical properties (i.e., numerical aperture, attenuation, effective modal bandwidth, and overfilled launch bandwidth). However, the bandwidth of the modeled optical fibers (both the EM bandwidth and the OFL bandwidth) was maximized when Δ_{Cmax} was 0 Δ% and the radial width of the shelf portion (i.e., r₃−r₂) was less than 1 μm, indicating that a relatively high bandwidth multimode optical fiber can be achieved while significantly reducing (or even eliminating) the amount of GeO₂ in the core portion of the fiber by down-doping the core portion, the depressed index trench portion, and the outer cladding portion with fluorine.

Referring to FIG. 7 the bandwidths (Y-axis) of Examples 1, 6, 8, and 10 and Comparative Example A are plotted as a function of wavelength (X-axis). As shown in FIG. 7, embodiments of multimode optical fibers described herein can achieve relatively high bandwidths for operating windows centered at different wavelengths by adjusting parameters of the multimode optical fiber as indicated in the tables. The bandwidths achievable in different operating windows are in keeping with the bandwidth achievable with the conventional multimode optical fiber of Comparative Example A.

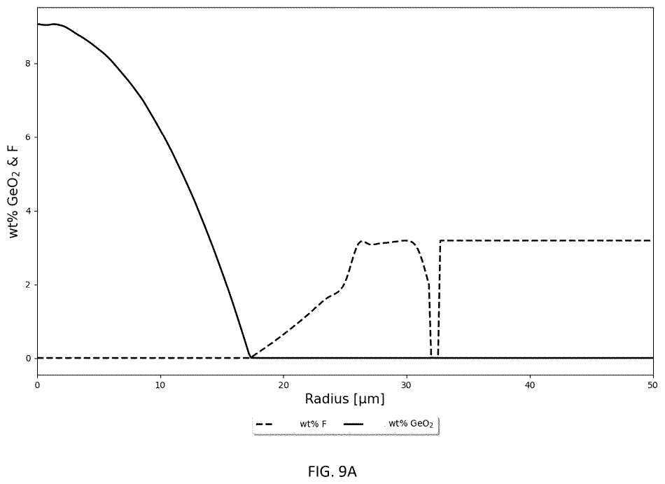

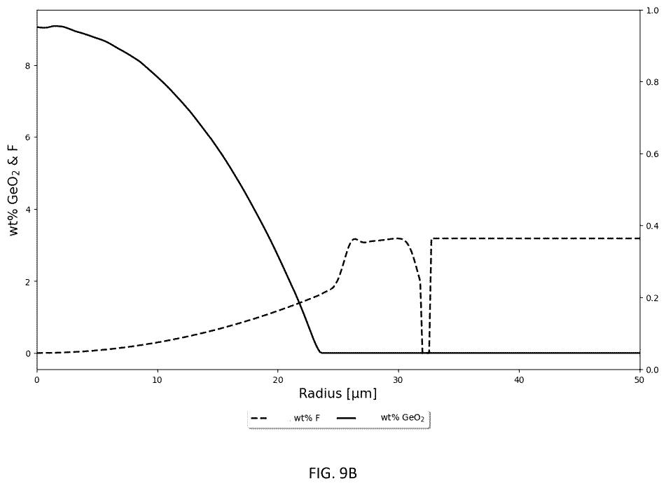

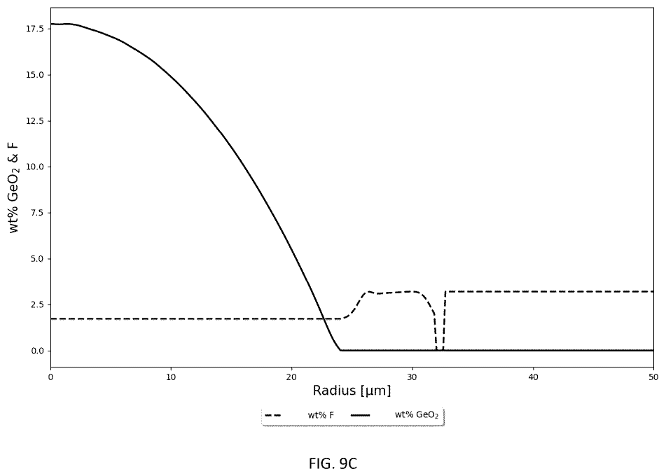

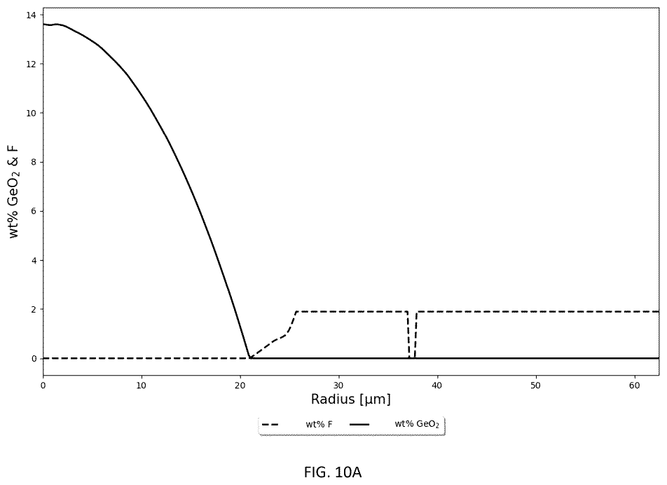

Referring now to FIGS. 8-12, FIGS. 8-12 graphically depict the doping concentration of GeO₂ and fluorine (Y-axis) as a function of fiber radius (X-axis) for Comparative Ex. A (FIG. 8) and examples of one or more embodiments of multimode optical fibers described herein (FIGS. 9A-12). Each of the multimode optical fibers was modeled with a graded index core having an α-profile, a radius r₁ of 25 microns, and a radius r₄ of 62.5 microns.

In particular, FIG. 8 shows that the conventional multimode optical fiber of Comparative Ex. A included GeO₂ but was free of fluorine in the core portion and the outer cladding portion of the optical fiber. The GeO₂ concentration was graded from a maximum at the centerline of the core portion (i.e., r=0) to the radius r₁ (i.e., r=25 μm) where the concentration of GeO₂ was a minimum.

In contrast, FIGS. 9A-9C show the doping concentration of GeO₂ and fluorine (Y-axis) as a function of fiber radius (X-axis) for embodiments of multimode optical fibers described herein, in particular Examples 1A-1C. As shown in FIGS. 9A-9C, the core portion of the optical fiber was modeled with both GeO₂ and fluorine to obtain the relative refractive index profile of Example 1, as depicted in FIG. 3. In particular, the concentration and/or distribution of each of GeO₂ and fluorine in the core portion of each of Examples 1A-1C were adjusted while still achieving the same relative refractive index profile of Example 1 depicted in FIG. 3, demonstrating that various combinations of GeO₂ and fluorine can be utilized to achieve the same relative refractive index profile in the core portion. In each of Examples 1A-1C, the concentration of GeO₂ in the core portion was graded from a maximum at or proximate to the centerline C_{L} of the core portion (i.e., r=0 μm) to a minimum between the centerline C_{L} of the core portion and the radius r₁ (i.e., r=25 μm) of the core portion. For Example 1A (FIG. 9A), the concentration of fluorine in the core portion was a minimum (specifically 0 wt %) at the centerline of the core portion and increased from the minimum in the outward radial direction starting at a point between the centerline C_{L} of the core portion and the radius r₁ of the core portion coinciding with the minimum concentration of GeO₂ in the core portion. The concentration of fluorine in the core portion was a maximum at the radius r₁ of the core portion.

For Example 1B (FIG. 9B), the concentration of fluorine in the core portion was a minimum (specifically 0 wt %) at the centerline C_{L} of the core portion and increased from the minimum starting at the centerline C_{L} of the core portion to a maximum at the radius r₁ of the core portion.

For Example 1C (FIG. 9C), the concentration of GeO₂ in the core portion was graded from a maximum of 17.7 wt % at or proximate to the centerline CI, of the core portion (i.e., r=0 μm)) to a minimum between the centerline C_{L} of the core portion and the radius r₁ (i.e., r=25 μm) of the core portion. The concentration of fluorine in the core portion was substantially uniform throughout the core portion from the centerline C_{L} of the core portion (i.e., r=0 μm)) to the radius r₁ (i.e., r=25 μm). Fluorine doping concentrations as depicted in FIG. 9C may be used to offset (i.e., decrease) the increase in the relative refractive index of the core portion due to the doping of GeO₂ in the core portion.

Doping concentrations as depicted in FIGS. 9A-9C provided for a maximum core relative refractive index Δ_{Cmax} of less than 1 Δ% and a minimum core relative refractive index Δ_{Cmin} of less than 0 Δ% while still maintaining a relatively high absolute core relative refractive index Δ_{Cabs}.

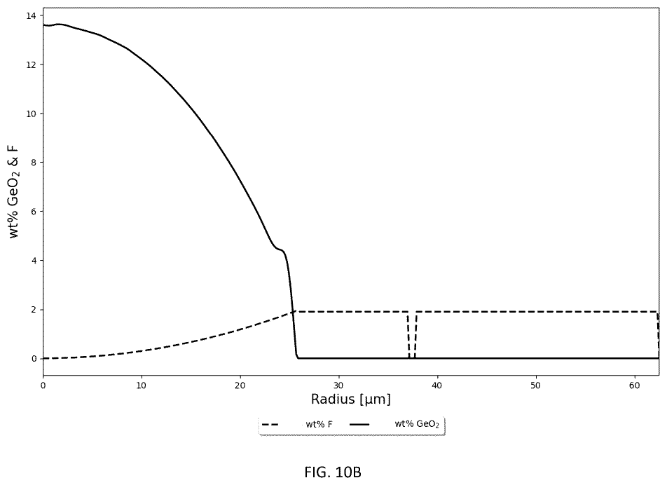

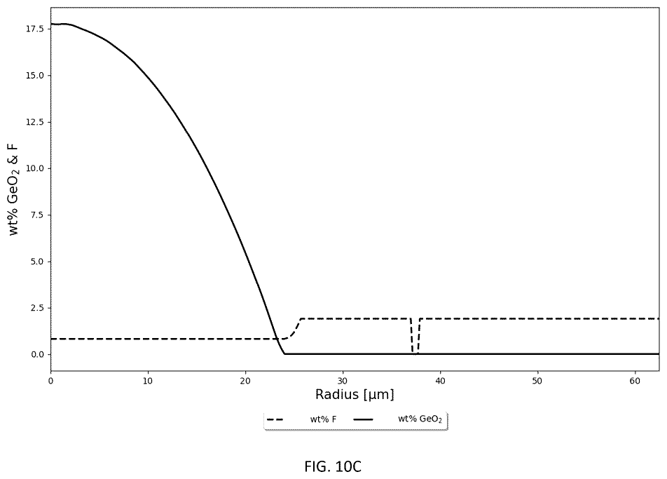

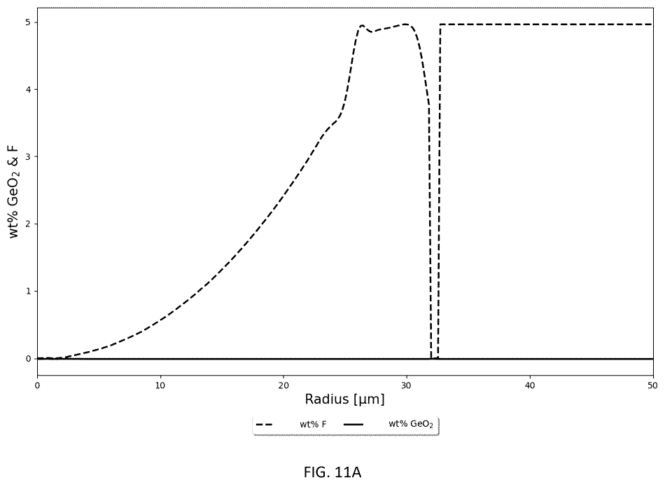

FIGS. 10A-10C show the doping concentration of GeO₂ and fluorine (Y-axis) as a function of fiber radius (X-axis) for embodiments of multimode optical fibers described herein, in particular Examples 4A-4C. As shown in FIGS. 10A-10C, the core portion of the optical fiber was modeled with both GeO₂ and fluorine to obtain the relative refractive index profile of Example 4, as described herein and depicted in FIG. 3. In particular, the concentration and/or distribution of each of GeO₂ and fluorine in the core portion of each of Examples 4A-4C were adjusted while still achieving the same relative refractive index profile of Example 4 depicted in FIG. 3, demonstrating that various combinations of GeO₂ and fluorine can be utilized to achieve the same relative refractive index profile in the core portion. In each of Examples 4A and 4C (FIGS. 10A and 10C), the concentration of GeO₂ in the core portion was graded from a maximum at or proximate to the centerline C_{L} of the core portion (i.e., r=0 μm) to a minimum between the centerline C_{L} of the core portion and the radius r₁ (i.e., r=25 μm) of the core portion. For Example 4B (FIG. 10B), the concentration of GeO₂ in the core portion was graded from a maximum at or proximate to the centerline of the core portion (i.e., r=0 μm) to a minimum at the radius r₁ (i.e., r=25 μm) of the core portion.

For Example 4A (FIG. 10A), the concentration of fluorine in the core portion was a minimum (specifically 0 wt %) at the centerline C_{L} of the core portion and increased from the minimum in the outward radial direction starting at a point between the centerline C_{L} of the core portion and the radius r₁ of the core portion coinciding with the minimum concentration of GeO₂ in the core portion. The concentration of fluorine in the core portion was a maximum at the radius r₁ of the core portion.

For Example 4B (FIG. 10B), the concentration of fluorine in the core portion was a minimum (specifically 0 wt %) at the centerline C_{L} of the core portion and increased from the minimum starting at the centerline C_{L} of the core portion to a maximum at the radius r₁ of the core portion.

For Example 4C (FIG. 10C), the concentration of GeO₂ in the core portion was graded from a maximum of 17.7 wt % at or proximate to the centerline C_{L} of the core portion (i.e., r=0 μm)) to a minimum between the centerline C_{L} of the core portion and the radius r₁ (i.e., r=25 μm) of the core portion. The concentration of fluorine in the core portion was substantially uniform throughout the core portion from the centerline C_{L} of the core portion (i.e., r=0 μm)) to the radius r₁ (i.e., r=25 μm).

Doping concentrations as depicted in FIGS. 10A-10C provided for a maximum core relative refractive index Δ_{Cmax} of less than 1 Δ% and a minimum core relative refractive index Δ_{Cmin} of less than 0 Δ% while still maintaining a relatively high absolute core relative refractive index Δ_{Cabs}.

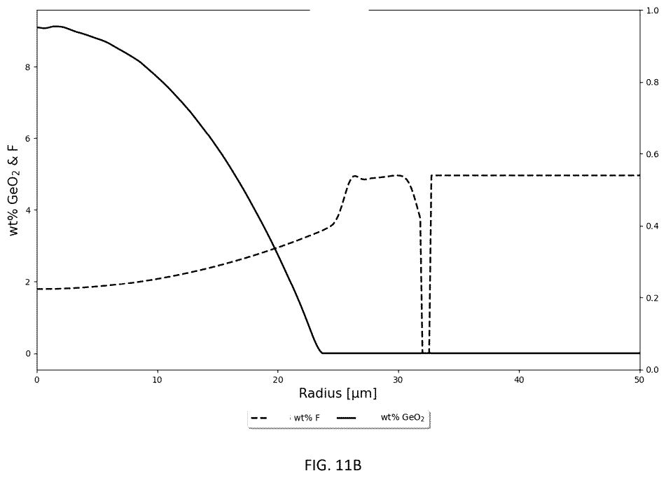

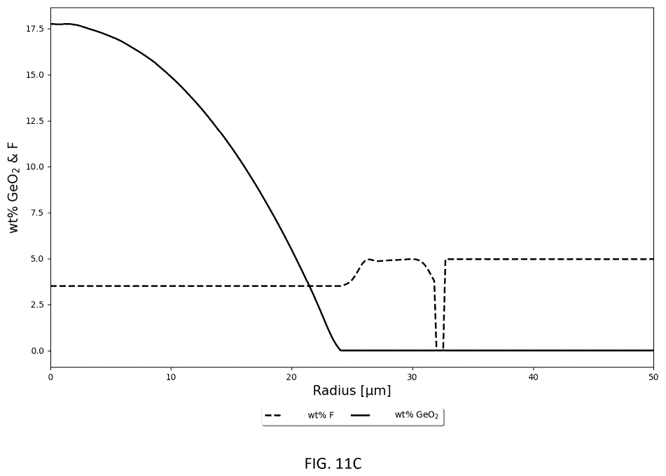

FIGS. 11A-11C graphically depict the doping concentration of GeO₂ and fluorine (Y-axis) as a function of fiber radius (X-axis) for example embodiments of multimode optical fibers described herein, specifically Examples 5A-5C. As shown in FIGS. 11A-11C, the core portion of the optical fiber was modeled with fluorine and without GeO₂ (Example 5A/FIG. 11A) or with both GeO₂ and fluorine (Examples 5B and 5C/FIGS. 11B and 11C) to obtain the relative refractive index profile of Example 5, as described herein and depicted in FIG. 3. In particular, the concentration and/or distribution of each of GeO₂ (when included) and fluorine in the core portion of each of Examples 5A-5C were adjusted while still achieving the same relative refractive index profile of Example 5 depicted in FIG. 3, demonstrating that various combinations of GeO₂ and fluorine can be utilized to achieve the same relative refractive index profile in the core portion.

For Example 5A (FIG. 11A), the core portion of the multimode optical fiber was modeled as containing fluorine but not GeO₂. The concentration of fluorine in the core portion was graded from at or proximate to the centerline C_{L} of the core portion (i.e., r=0) to the radius r₁ (i.e., r=25 μm) to achieve the parabolic shape of the α-profile of the core portion. Specifically, the concentration of fluorine in the core portion was a minimum at or proximate the centerline C_{L} of the core portion and increased from the minimum in the outward radial direction relative to the centerline C_{L} and was a maximum at the radius r₁ of the core portion. This doping concentration demonstrates that GeO₂ may be completely eliminated from the fiber while still achieving the desired relative refractive index profile.

For Example 5B (FIG. 11B), the core portion of the optical fiber was modeled with both GeO₂ and fluorine to obtain an α-profile. In this example, the concentration of GeO₂ in the core portion was graded from a maximum of 9.1 wt % at or proximate to the centerline C_{L} of the core portion (i.e., r=0 μm)) to a minimum between the centerline C_{L} of the core portion and the radius r₁ (i.e., r=25 μm) of the core portion. The concentration of fluorine in the core portion was a minimum at the centerline C_{L} of the core portion and increased from the minimum starting at the centerline C_{L} of the core portion to a maximum at the radius r₁ of the core portion.

For Example 5C (FIG. 11C), the core portion of the optical fiber was modeled with both GeO₂ and fluorine to obtain an α-profile. In this example, the concentration of GeO₂ in the core portion was graded from a maximum of 17.7 wt % at or proximate to the centerline C_{L} of the core portion (i.e., r=0 μm)) to a minimum between the centerline C_{L} of the core portion and the radius r₁ (i.e., r=25 μm) of the core portion. The concentration of fluorine in the core portion was substantially uniform throughout the core portion from the centerline of the core portion (i.e., r=0 μm)) to the radius r₁ (i.e., r=25 μm). Fluorine doping concentrations as depicted in FIGS. 11A-11C may be used to offset (i.e., decrease) the increase in the relative refractive index of the core portion due to the doping of GeO₂ in the core portion.

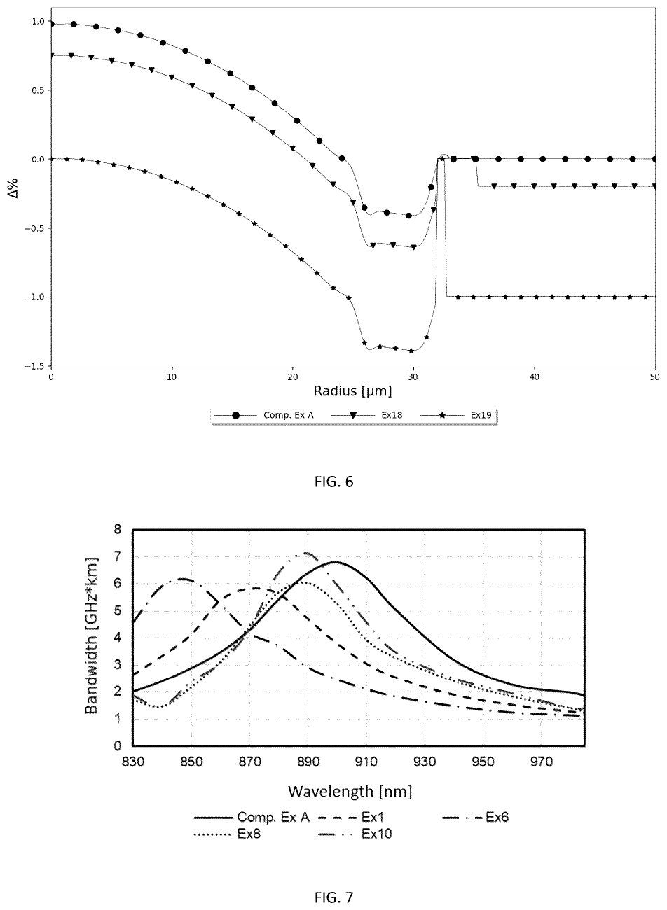

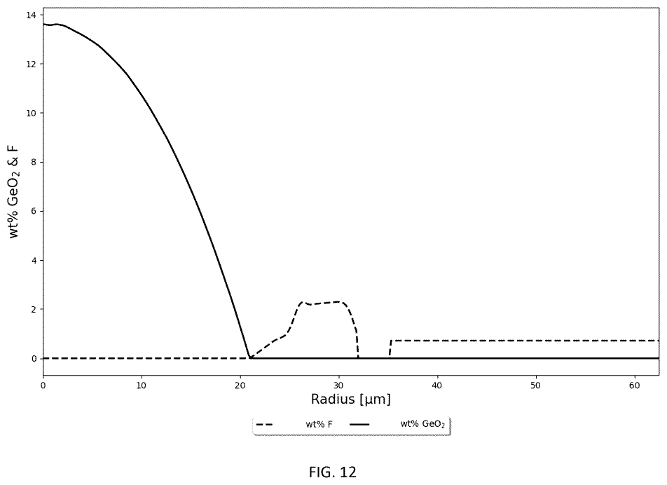

FIG. 12 graphically depicts the doping concentration of GeO₂ and fluorine (Y-axis) as a function of fiber radius (X-axis) for an example of one embodiment of a multimode optical fiber described herein, specifically Example 18. As shown in FIG. 12, the core portion of the optical fiber was modeled with both GeO₂ and fluorine to obtain the α-profile of Example 18 as depicted in FIG. 6. The concentration of GeO₂ in the core portion was graded from a maximum at or proximate to the centerline C_{L} of the core portion (i.e., r=0 μm) to a minimum between the centerline C_{L} of the core portion and the radius r₁ (i.e., r=25 μm) of the core portion. The concentration of fluorine in the core portion was a minimum (specifically 0 wt %) at the centerline C_{L} of the core portion and increased from the minimum in the outward radial direction starting at a point between the centerline C_{L} of the core portion and the radius r₁ of the core portion coinciding with the minimum concentration of GeO₂ in the core portion. The concentration of fluorine in the core portion was a maximum at the radius r₁ of the core portion.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A multimode optical fiber comprising:
a core portion comprising an α-profile, a core maximum relative refractive index Δ_{Cmax} at or proximate a centerline of the core portion, and a core minimum relative refractive index Δ_{Cmin} at an outer radius of the core portion, wherein Δ_{Cmax} is less than or equal to 0.85 Δ% and greater than or equal to −0.1 Δ%, Δ_{Cmax}>Δ_{Cmin}, and Δ_{Cmin} is less than 0 Δ%;
a depressed index trench portion circumferentially surrounding the core portion, the depressed index trench portion comprising a minimum relative refractive index Δ_{Tmin};
a shelf portion circumferentially surrounding and directly contacting the depressed index trench portion, the shelf portion comprising a maximum relative refractive index Δ_{Smax}; and
an outer cladding portion circumferentially surrounding and directly contacting the shelf portion, the outer cladding portion comprising a relative refractive index Δ_{OC}, wherein:
$${Δ}_{Cmin} > {Δ}_{Tmin} ;$$
$${Δ}_{Cmax} \geq {Δ}_{Smax} ;$$
$${Δ}_{Smax} > {Δ}_{Tmin} ;$$
$${Δ}_{Smax} > {Δ}_{OC} ;$$
each of the core portion, the depressed index trench portion, and the outer cladding portion comprise silica-based glass down-doped with fluorine; and
the multimode optical fiber is multimoded at wavelengths up to 1600 nm.

2. The multimode optical fiber of claim 1, wherein Δ_{OC}≥Δ_{Tmin}.

3. The multimode optical fiber of claim 1, wherein Δ_{Smax}≥Δ_{Cmin}.

4. The multimode optical fiber of claim 1, wherein a core absolute relative refractive index Δ_{Cabs} of the core portion is greater than or equal to 0.85 Δ% and less than or equal to 1.3 Δ%.

5. The multimode optical fiber of claim 1, wherein an α-value of the α-profile of the core portion is greater than or equal to 1.75 and less than or equal to 2.25 such that the α-profile is parabolic.

6. The multimode optical fiber of claim 1, wherein Δ_{Cmin} is less than or equal to 0 Δ% and greater than or equal to −1 Δ%.

7. The multimode optical fiber of claim 1, wherein Δ_{Cmax} is less than or equal to 0.0 Δ% and greater than or equal to −0.1 Δ%.

8. The multimode optical fiber of claim 1, wherein the core portion further comprises GeO₂, and wherein the multimode optical fiber satisfies one of:
a concentration of GeO₂ in the core portion is a maximum at or proximate the centerline of the core portion and decreases from the maximum in an outward radial direction relative to the centerline, and a concentration of fluorine in the core portion is a minimum at or proximate the centerline of the core portion;
a concentration of GeO₂ in the core portion is substantially uniform throughout the core portion, and a concentration of fluorine in the core portion is a minimum at or proximate the centerline of the core portion and increases from the minimum in an outward radial direction relative to the centerline; or
a concentration of fluorine in the core portion is substantially uniform throughout the core portion, and a concentration of GeO₂ in the core portion is a maximum at or proximate the centerline of the core portion and decreases from the maximum in an outward radial direction relative to the centerline.

9. The multimode optical fiber of claim 1, wherein a maximum concentration of GeO₂ in the core portion is greater than 0 wt % and less than or equal to 20.5 wt %.

10. The multimode optical fiber of claim 1, wherein a concentration of fluorine in the core portion is a minimum at or proximate the centerline of the core portion and increases from the minimum in an outward radial direction relative to the centerline.

11. The multimode optical fiber of claim 1, wherein:
a maximum concentration of fluorine in the core portion is greater than 0 wt % and less than or equal to 7.5 wt %; or
a concentration of fluorine in the outer cladding portion is greater 0 wt % to less than or equal to 7.5 wt %.

12. The multimode optical fiber of claim 1, wherein the core portion comprises a radial width greater than or equal to 15 μm and less than or equal to 35 μm.

13. The multimode optical fiber of claim 1, wherein Δ_{Tmin} is greater than or equal to −1.5 Δ% and less than or equal to −0.2 Δ%.

14. The multimode optical fiber of claim 1, wherein the depressed index trench portion comprises a radial width of greater than or equal to 2 μm and less than or equal to 15 μm.

15. The multimode optical fiber of claim 1, wherein the shelf portion is pure silica glass or silica doped with fluorine.

16. The multimode optical fiber of claim 15, wherein a maximum concentration of fluorine in the shelf portion is greater than or equal to 0 wt % and less than or equal to 1.4 wt %.

17. The multimode optical fiber of claim 1, wherein Δ_{Smax} is greater than or equal to −0.4 Δ% and less than or equal to 0 Δ%.

18. The multimode optical fiber of claim 1, wherein the shelf portion comprises a radial width greater than 0 μm and less than or equal to 10 μm.

19. The multimode optical fiber of claim 1, wherein Δ_{OC} is greater than or equal-1.5 Δ% and less than or equal to −0.2 Δ%.

20. The multimode optical fiber of claim 1, wherein the multimode optical fiber comprises at least one of:
a bandwidth of greater than or equal to 0.05 GHz-km and less than or equal to 10 GHz-km for each wavelength within a wavelength operating window centered on at least one wavelength within an operating wavelength range from about 820 nm to about 1310 nm, the wavelength operating window having a width greater than 100 nm;
an effective modal bandwidth according to IEC 60793-1-49 of greater than or equal to 0.020 GHz-km and less than or equal to 10.000 GHz-km;
an OFL bandwidth of greater than or equal to 0.050 GHz-km and less than or equal to 10.000 GHz-km;
a macrobend loss of less than or equal to 0.50 db/(2 turns around a 15 mm diameter mandrel) at 850 nm;
a macrobend loss of less than or equal to 0.50 db/(2 turns around a 15 mm diameter mandrel) at 1300 nm;
a numerical aperture of greater than or equal to 0.150 and less than or equal to 0.250; or
an attenuation of less than 0.25 db/km at a wavelength of 1310 nm.
